(19) United States
(12) Patent Application Publication
(10) Pub. No.: US 2025/0008402 A1
(43) Pub. Date: Jan. 2, 2025

(54) COMMUNICATION APPARATUS AND CONTROL METHOD

(71) Applicant: CANON KABUSHIKI KAISHA, Tokyo (JP)

(72) Inventor: KEIGO TSUCHIYA, Chiba (JP)

(21) Appl. No.: 18/757,164

(22) Filed: Jun. 27, 2024

(30) Foreign Application Priority Data
Jun. 30, 2023 (JP) 2023-107819

(51) Int. Cl. H04W 36/14

(52) U.S. Cl. CPC H04W 36/14

(57) ABSTRACT

A communication apparatus includes a control unit that performs, in a state in which the communication apparatus concurrently operates in a first mode and in a second mode, predetermined control to prevent a destination to which the communication apparatus is connected in the first mode from being switched based on predetermined information, from a first network to a network in which a channel used by the communication apparatus in the second mode is used.

### BACKGROUND

### Field

The present disclosure relates to a communication apparatus and a control method.

### Description of the Related Art

Japanese Patent Laid-Open No. 2013-157943 proposes a technique in which a wireless communication apparatus matches a channel used for connection to an access point with a channel used for connection to a mobile terminal via Wi-Fi Direct (WFD).

As apparatuses that can operate in a mode as slave stations and operate in another mode as master stations become widespread, it becomes desirable to improve the usability of the apparatuses.

### SUMMARY

The present disclosure has been made to solve the above-described problem, among other things, and provides a communication apparatus that can operate in a first mode as a slave station compliant with a predetermined wireless communication standard and operate in a second mode as a master station compliant with the predetermined wireless communication standard. The communication apparatus includes a specifying unit, a first control unit, a switching unit, and a second control unit. The specifying unit specifies, in a case that specific processing for causing the communication apparatus to operate in the first mode is performed in a state in which the communication apparatus operates in the second mode, a channel (i) that is different from a channel used by the communication apparatus in the second mode when the specific processing is performed and (ii) that is to be used by the communication apparatus in the second mode after the specific processing is performed, based on a match between the channel used by the communication apparatus in the second mode when the specific processing is performed and a channel used by the communication apparatus in the first mode started by the specific processing. The first control unit controls the communication apparatus such that the communication apparatus concurrently operates in the first mode and the second mode, and operates in the second mode using the specified channel in a case that the specific processing is performed in a state in which the communication apparatus operates in the second mode. The switching unit switches a destination to which the communication apparatus is connected in the first mode from a first network to a second network based on reception of predetermined information by the communication apparatus via the first network to which the communication apparatus is connected in the first mode in a state in which the communication apparatus operates in the first mode. The predetermined information is provided for switching the destination to which the communication apparatus is connected in the first mode from the first network to the second network. The second control unit performs, in a state in which the communication apparatus concurrently operates in the first mode and in the second mode, predetermined control to prevent the destination to which the communication apparatus is connected in the first mode from being switched based on the predetermined information, from the first network to a network in which the channel used by the communication apparatus in the second mode is used.

Further features of the present disclosure will become apparent from the following description of exemplary embodiments with reference to the attached drawings.

### BRIEF DESCRIPTION OF THE DRAWINGS

FIG. 1 is a diagram illustrating an example of a configuration of a communication system.

FIGS. 2A to 2F are diagrams illustrating examples of screens displayed by an operation display unit of a communication apparatus.

FIGS. 3A and 3B are diagrams illustrating examples of a wireless connection sequence in a direct connection mode.

FIG. 4 is a diagram illustrating an example of a wireless connection sequence in an infrastructure connection mode.

FIG. 5 is a sequence diagram illustrating a process to be performed by Wi-Fi Agile Multiband.

FIG. 6 is a diagram illustrating the arrangement of channels for each frequency band.

FIG. 7 is a flowchart illustrating a process to be performed by the communication apparatus.

FIG. 8 is a flowchart illustrating a process to be performed by the communication apparatus.

FIG. 9 is a flowchart illustrating a process to be performed by the communication apparatus.

FIG. 10 is a flowchart illustrating a process to be performed by the communication apparatus according to a second embodiment.

FIG. 11 is a flowchart illustrating a process to be performed by the communication apparatus.

FIG. 12 is a flowchart illustrating a process to be performed by the communication apparatus.

FIG. 13 is a flowchart illustrating a process to be performed by the communication apparatus.

FIG. 14 is a flowchart illustrating a process to be performed by the communication apparatus.

### DESCRIPTION OF THE EMBODIMENTS

Hereinafter, example embodiments of the present disclosure will be described. However, regarding the present disclosure, it is to be understood that modifications and improvements can be made to the embodiments described below based on common knowledge of those skilled in the art without departing from the spirit of the present disclosure and that such modified embodiments also fall within the scope of the present disclosure.

### First Embodiment

An information processing apparatus and a communication apparatus included in a communication system according to the present embodiment will be described. As the information processing apparatus, a smartphone is exemplarily described in the present embodiment. However, the information processing apparatus is not limited thereto. As the information processing apparatus, a mobile terminal, a laptop personal computer (PC), a tablet terminal, a personal digital assistant (PDA), a digital camera, and the like can be used. In addition, as the communication apparatus, a printer is exemplarily described in the present embodiment. However, the communication apparatus is not limited thereto. Various apparatuses can be used as the communication apparatus as long as the apparatuses can perform wireless communication with the information processing apparatus. For example, in a case where a printer is used as the communication apparatus, an ink jet printer, a full-color laser beam printer, a monochrome printer, and the like can be used as the communication apparatus. Furthermore, not only printers but also a copying machine, a facsimile machine, a mobile terminal, a smartphone, a laptop PC, a tablet terminal a PDA, a digital camera, a music playing device, a television, a smart speaker, and the like can be used as the communication apparatus. Furthermore, a multi-function peripheral having a plurality of functions including a copy function, a facsimile function, and a print function can be used as the communication apparatus.

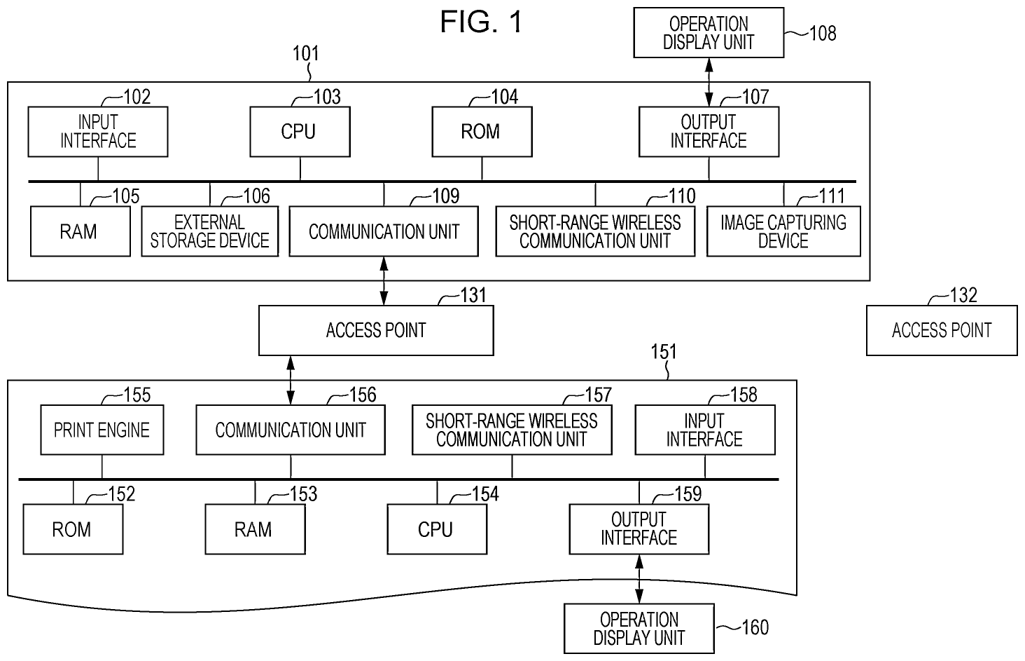

First, configurations of the information processing apparatus included in the communication system according to the present embodiment and the communication apparatus that can communicate with the information processing apparatus will be described with reference to a block diagram of FIG. 1. The following configurations will be described as an example in the present embodiment, but functions are not particularly limited to those illustrated in FIG. 1.

The information processing apparatus 101 includes an input interface 102, a CPU 103, a ROM 104, a RAM 105, an external storage 106, an output interface 107, an operation display unit 108, a communication unit 109, a short-range wireless communication unit 110, and an image capturing device 111.

The input interface 102 receives data input and an operation instruction from a user and includes a physical keyboard, buttons, a touch panel, and the like. The output interface 107 described later and the input interface 102 may be included in the same configuration, and output of a screen and reception of an operation from the user may be performed in the same configuration.

The CPU 103 is a system control unit and controls the entire information processing apparatus 101.

The ROM 104 stores fixed data such as a control program to be executed by the CPU 103, a data table, and an embedded operating system (hereinafter referred to as an OS) program. In the present embodiment, control programs stored in the ROM 104 perform software execution control such as scheduling, task switching, and interruption processing under management by the embedded OS program stored in the ROM 104.

The RAM 105 includes a static random access memory (SRAM) that requires a backup power source. Since data is held in a primary battery (not illustrated) for data backup, important data such as a program control variable can be stored in the RAM 105 without being volatile. In addition, a memory area for storing setting information of the information processing apparatus 101, management data of the information processing apparatus 101, and the like is provided in the RAM 105. The RAM 105 is also used as a main memory and a work memory of the CPU 103.

The external storage 106 includes an application (hereinafter referred to as a print application) that provides a print execution function. In addition, the external storage 106 includes various programs including a print information generation program for generating print information that can be interpreted by the communication apparatus 151 and an information transmission and reception control program for transmitting and receiving information to and from the communication apparatus 151 connected to the information processing apparatus 101 via the communication unit 109. The external storage 106 stores various types of information that is used by these programs. The external storage 106 also stores image data acquired from another information processing apparatus and the Internet via the communication unit 109.

The output interface 107 controls displaying of data by the operation display unit 108 and notification of the state of the information processing apparatus 101 by the operation display unit 108.

The operation display unit 108 includes a light emitting diode (LED) and a liquid crystal display (LCD). The operation display unit 108 displays data and notifies the state of the information processing apparatus 101. A software keyboard that includes keys including a numeral input key, a mode setting key, a determination key, a cancel key, and a power supply key may be provided on the operation display unit 108, and the information processing apparatus 101 may receive input from the user via the operation display unit 108.

The communication unit 109 is connected to an apparatus such as the communication apparatus 151 and configured to perform data communication. For example, the communication unit 109 can be connected to an access point (not illustrated) within the communication apparatus 151. In a case that the communication unit 109 is connected to the access point within the communication apparatus 151, the information processing apparatus 101 and the communication apparatus 151 can communicate with each other. An access point is hereinafter also referred to as an AP. The communication unit 109 may directly wirelessly communicate with the communication apparatus 151 or may communicate with the communication apparatus 151 via an access point 131 or the like that is present outside the information processing apparatus 101 and the communication apparatus 151. In the present embodiment, it is assumed that, as a wireless communication method, the IEEE802.11 series of standards is used.

The IEEE802.11 series of standards is known as Wireless Fidelity (Wi-Fi) (registered trademark). In the present embodiment, it is assumed that the communication apparatus 151 can perform communication as a station compliant with the IEEE802.11 series of standards. Hereinafter, the station is also referred to as an STA. In addition, the station corresponds to a slave station (child station) for Wi-Fi. The slave station for Wi-Fi is an apparatus that does not determine a channel to be used for Wi-Fi connection and uses, for Wi-Fi connection, a channel determined by a master station (parent station) as a channel to be used for Wi-Fi connection. In the present embodiment, it is assumed that the communication apparatus 151 supports a Wi-Fi Agile Multiband (registered trademark) feature and can perform communication as an STA supporting Wi-Fi Agile Multiband. In addition, it is assumed that the communication apparatus 151 also supports a Wi-Fi 6 (registered trademark) feature compliant with the IEEEE802.11ax standard.

Therefore, the communication apparatus 151 can perform an operation as an STA supporting Orthogonal Frequency-Division Multiple Access (OFDMA) and Target Wake Time (TWT) as the Wi-Fi 6 feature. The communication apparatus 151 as the STA can suppress power consumption by shifting a communication function to a sleep state when the communication apparatus 151 does not need to stand by to receive a signal. Specifically, the communication apparatus 151 may support a Wi-Fi 6E (registered trademark) feature as the Wi-Fi 6 feature. That is, the communication apparatus 151 may be able to perform communication in the 6 GHz frequency band (from 5.925 GHz to 7.125 GHz). Unlike the 5 GHz frequency band, the 6 GHz frequency band does not include a target band in which dynamic frequency selection (DFS) is performed. Therefore, in communication in the 6 GHz frequency band, communication disconnection due to the time for waiting for DFS does not occur.

As described above, in the present embodiment, the communication apparatus 151 supports Wi-Fi Agile Multiband and Wi-Fi 6, but is not limited thereto. For example, the communication apparatus 151 may support Wi-Fi Agile Multiband without supporting Wi-Fi 6.

As the access point 131, for example, a device such as a wireless LAN router may be used. In the present embodiment, a method in which the information processing apparatus 101 and the communication apparatus 151 are directly connected to each other without an external access point is referred to as a direct connection method. In addition, a method in which the information processing apparatus 101 and the communication apparatus 151 are connected to each other via the external access point 131 or the like is referred to as an infrastructure connection method.

The short-range wireless communication unit 110 is wirelessly connected to an apparatus such as the communication apparatus 151 in a short distance and performs communication using a communication method different from that of the communication unit 109. A short-range wireless communication method used by the short-range wireless communication unit 110 is, for example, Bluetooth (registered trademark) or near-field communication (NFC). As Bluetooth, Bluetooth Classic or Bluetooth Low Energy may be used. The short-range wireless communication unit 110 can be connected to a short-range wireless communication unit 157 within the communication apparatus 151.

The image capturing device 111 converts an image captured by an image capturing element into digital data. The digital data is temporarily stored in the RAM 105. Thereafter, a program executed by the CPU 103 converts the digital data into data in a predetermined image format and stores the converted data as image data to the external storage 106.

A ROM 152 stores fixed data such as a control program to be executed by a CPU 154, a data table, and an OS program.

The communication apparatus 151 includes the ROM 152, a RAM 153, the CPU 154, a print engine 155, a communication unit 156, the short-range wireless communication unit 157, an input interface 158, an output interface 159, and an operation display unit 160. In a case that a connection mode (communication mode) is set in the communication apparatus 151, the communication apparatus 151 can operate in the set connection mode.

The communication unit 156 is configured for the communication apparatus 151 to communicate with another apparatus. In the present embodiment, it is assumed that the communication unit 156 performs communication in accordance with the IEEE802.11 series of standards. The communication unit 156 includes, as the access point within the communication apparatus 151, an access point for connection to an apparatus such as the information processing apparatus 101. The access point can be connected to the communication unit 109 of the information processing apparatus 101. The communication unit 156 may directly wirelessly communicate with the information processing apparatus 101 or may wirelessly communicate with the information processing apparatus 101 via the access point 131. In addition, the communication unit 156 may include hardware that functions as the access point. Alternatively, the communication unit 156 may operate as the access point by using software for causing the communication unit 156 to function as the access point. In the present embodiment, it is assumed that the communication unit 156 and the short-range wireless communication unit 157 are implemented by a single wireless chip. That is, in the present embodiment, it is assumed that a combo chip that supports both a communication function compliant with the IEEE802.11 series of standards and a communication function compliant with the short-range wireless communication method is used as the wireless chip. However, the wireless chip is not limited thereto. The communication unit 156 and the short-range wireless communication unit 157 may be implemented by different wireless chips. In addition, in the present embodiment, it is assumed that a wireless chip supporting a dynamic rapid channel switching (DRCS) function is used. The DRCS function is used when communication via the infrastructure connection and communication via the direct connection are performed in a time-division manner during a concurrent operation described later. Specifically, the DRCS function is a function of switching, at high speed, a communication channel in use between a state in which communication via the infrastructure connection is performed and a state in which communication via the direct connection is performed. A communication channel is hereinafter merely referred to as a channel. Therefore, in the present embodiment, during the concurrent operation, a channel used for communication via the infrastructure connection can be different from a channel used for communication via the direct connection. However, the present embodiment is not limited thereto. For example, the communication unit 156 may be implemented by two or more wireless chips including a wireless chip for an infrastructure connection mode and a wireless chip for a direct connection mode. Therefore, during the concurrent operation, a channel used for communication via the infrastructure connection may be different from a channel used for communication via the direct connection.

The RAM 153 includes a DRAM or the like that requires a backup power source. Data is held in the RAM 153 by supply of electric power (not illustrated) for data backup. Therefore, important data such as a program control variable can be stored in the RAM 153 without being volatile. In addition, the RAM 153 is used as a main memory and a work memory of the CPU 154 and stores various types of information as a receiving buffer for temporarily storing print information received from the information processing apparatus 101 or the like.

The ROM 152 stores fixed data such as the control program to be executed by the CPU 154, the data table, and the OS program. In the present embodiment, control programs stored in the ROM 152 perform software execution control such as scheduling, task switching, and interruption processing under management by the embedded OS stored in the ROM 152. In addition, the ROM 152 includes a memory area for storing data that is setting information of the communication apparatus 151, management data of the communication apparatus 151, and the like and is required to be held even in a case that electric power is not supplied.

The CPU 154 is a system control unit and controls the entire communication apparatus 151.

The print engine 155 uses a recording material such as ink to form an image on a recording medium such as paper and outputs a print result based on information stored in the RAM 153 and a print job received from the information processing apparatus 101 or the like. In this case, the print job transmitted from the information processing apparatus 101 or the like has a large amount of transmission data, high-speed communication is required, and thus the print job is received via the communication unit 156 that can perform communication at higher speed than the short-range wireless communication unit 157.

The short-range wireless communication unit 157 is wirelessly connected to an apparatus such as the information processing apparatus 101 in a short distance and configured to perform data communication. The short-range wireless communication unit 157 performs communication using a communication method different from that of the communication unit 156. The short-range wireless communication method used by the short-range wireless communication unit 157 is Bluetooth (registered trademark) or NFC. As Bluetooth, Bluetooth Classic or Bluetooth Low Energy may be used. The short-range wireless communication unit 157 can be connected to the short-range wireless communication unit 110.

The input interface 158 receives data input and an operation instruction from the user and includes a physical keyboard, buttons, a touch panel, and the like. The output interface 159 described later and the input interface 158 may be included in the same configuration, and output of a screen and reception of an operation from the user may be performed in the same configuration. The output interface 159 controls displaying of data by the operation display unit 160 and notification of the state of the communication apparatus 151 by the operation display unit 160.

The operation display unit 160 includes a light emitting diode (LED) and a liquid crystal display (LCD). The operation display unit 160 displays data and notifies the state of the communication apparatus 151. A software keyboard that includes keys including a numeral input key, a mode setting key, a determination key, a cancel key, and a power supply key may be provided on the operation display unit 160, and the communication apparatus 151 may receive input from the user via the operation display unit 160. Examples of Screens Displayed by Operation Display Unit 160

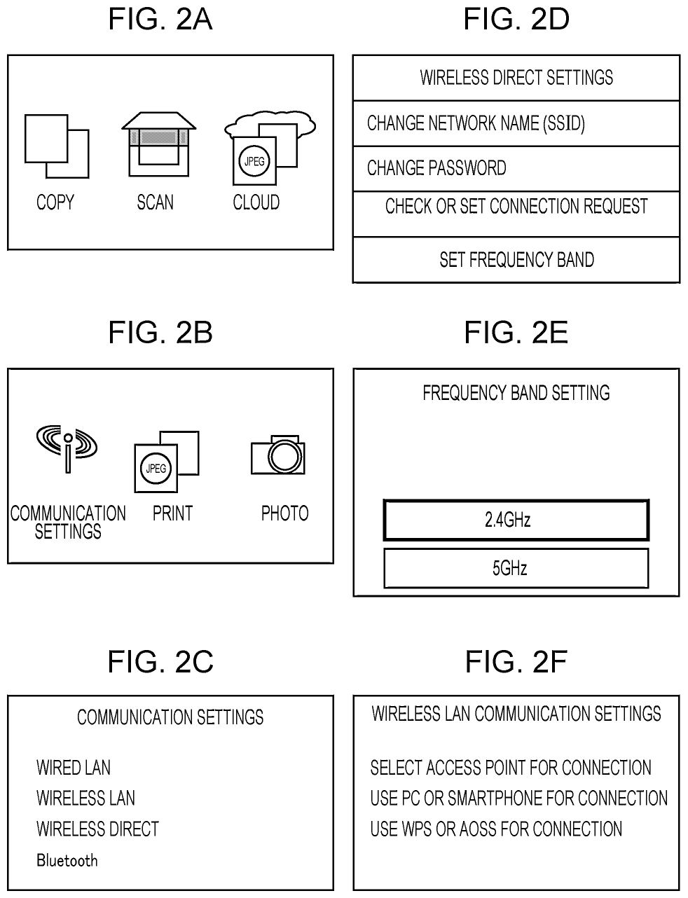

FIGS. 2A to 2F schematically illustrate examples of screens displayed by the operation display unit 160 of the communication apparatus 151. FIG. 2A illustrates an example of a home screen displayed in a state (idle state or a standby state) in which the communication apparatus 151 is powered on and does not perform operations such as printing and scanning. In FIG. 2A, a menu for a copy function, a menu for a scan function, and a menu for a cloud function are displayed. The communication apparatus 151 can seamlessly display a screen different from the screen illustrated in FIG. 2A by receiving a key operation on the screen illustrated in FIG. 2A or receiving a scroll operation on the touch panel. FIG. 2B illustrates a part of the home screen. In FIG. 2B, a menu for a print function, a menu for a photo function, a menu for a function of changing a communication setting are displayed. In a case that any of the menus is selected by a key operation or a touch panel operation by the user in a state in which the screen illustrated in FIGS. 2A and 2B is displayed, the communication apparatus 151 can start to execute a function corresponding to the selected menu.

FIG. 2C illustrates an example of a communication selection screen displayed in a case that the menu for the function of changing a communication setting is selected on the screen illustrated in FIG. 2B. This communication selection screen includes, for example, a menu for making a setting for a wired LAN, a menu for making a setting for a wireless LAN, a menu for making a setting for wireless direct, and a menu for making a setting for Bluetooth. The communication apparatus 151 can start to operate in the infrastructure connection mode (described later) in accordance with a setting executed in a case that the menu for making a setting for the wireless LAN is selected. In addition, the communication apparatus 151 can start to operate in the direct connection mode (described later) in accordance with a setting executed in a case that the menu for making a setting for wireless direct is selected. In a setting executed in a case that the menu for making a setting for Bluetooth is selected, a setting for enabling and disabling a Bluetooth function and a setting for pairing for Bluetooth may be made.

In the present embodiment, specifically, for example, in a case that the menu for making a setting for wireless direct is selected, a screen illustrated in FIG. 2D is displayed. A “change network name (SSID)” button is a button for the user to change a service set identifier (SSID) of the communication apparatus 151 operating in the direct connection mode to any value. A “change password” button is a button for the user to change a password for connection to the communication apparatus 151 operating in the direct connection mode to any value. A “enable/disable direct connection mode” button is a button for activating the direct connection mode (described later) and stopping the direct connection mode in a state in which the direct connection mode is activated. In the present embodiment, it is assumed that in a case that the “enable/disable direct connection mode” button is selected, a WFD mode (described later) is activated. However, the present embodiment is not limited thereto. In a case that the “enable/disable direct connection mode” button is selected, either a software AP mode (described later) or the WFD mode may be activated or both the software AP mode and the WFD mode may be activated. A “set frequency band” button is a button for the user to set a frequency band to be used by the communication apparatus 151 operating in the direct connection mode to perform communication in the direct connection mode. In a case that the “set frequency band” button is selected, a screen illustrated in FIG. 2E is displayed. In the present embodiment, the screen illustrated in FIG. 2E includes a region for selecting the 2.4 GHz frequency band and a region for selecting the 5 GHz frequency band. Therefore, the user can select the 2.4 GHz frequency band or the 5 GHz frequency band on the screen illustrated in FIG. 2E. In a case where the communication apparatus 151 also supports communication using the 6.0 GHz frequency band, the screen illustrated in FIG. 2E may include a region for selecting the 6.0 GHz frequency band and the user may be able to select the 6.0 GHz frequency band on the screen illustrated in FIG. 2E.

In the present embodiment, specifically, for example, in a case that the menu for making a setting for the wireless LAN is selected, a screen illustrated in FIG. 2F is displayed. A “select access point for connection” button is a button for establishing an infrastructure connection (described later) by a first method according to the present embodiment. The first method is a method in which the communication apparatus 151 establishes an infrastructure connection to an access point selected from a list of one or more access points found in a search by the communication apparatus 151. The first method will be described later in detail. A “use PC/smartphone for connection” button is a button for establishing an infrastructure connection of the communication apparatus 151 by a second method according to the present embodiment. The second method is a method in which information for connection to an access point is transmitted from the information processing apparatus such as a PC or a smartphone to the communication apparatus 151 and the communication apparatus 151 establishes the infrastructure connection to the access point by using the information. In a case that the “use PC/smartphone for connection” button is selected, the communication apparatus 151 operates as a software AP for connection to the PC or the smartphone. A “use WPS/AOSS for connection” button is a button for establishing an infrastructure connection of the communication apparatus 151 by a third method according to the present embodiment.

The third method is a method in which the communication apparatus 151 establishes an infrastructure connection to an access point by a known setting method such as Wi-Fi Protected Setup (WPS) or AirStation One-Touch Secure System (AOSS).

Methods in which the communication apparatus 151 establishes an infrastructure connection are not limited to the above-described methods. For example, to transmit connection information for connection to the access point 131 or the like to the communication apparatus 151, communication by the short-range wireless communication method or a Wi-Fi Easy Connect feature using the Device Provisioning Protocol (DPP) may be used. Buttons for establishing an infrastructure connection by the methods may be displayed on the screen illustrated in FIG. 2F.

### Regarding Direct Connection Method

The direct connection indicates a mode in which the apparatuses are directly wirelessly connected to each other (that is, in a peer-to-peer fashion) without an external apparatus such as the access point 131. The communication apparatus 151 can operate in the mode (direct connection mode) for communication via the direct connection. In Wi-Fi communication, a plurality of modes for communication via the direct connection, such as the software AP mode and the Wi-Fi Direct (WFD) mode, are present.

The WFD mode is a mode in which the direct connection is performed using WFD. WFD is a standard defined by Wi-Fi Alliance and is included in the IEEE802.11 series of standards. In the WFD mode, after an apparatus as a communication partner is found using an apparatus search command, roles of a P2P group owner (GO) and a P2P client are determined and remaining wireless connection processing is performed. The group owner corresponds to a Wi-Fi master station, and the client corresponds to a Wi-Fi slave station. The determination of the roles corresponds to P2P GO negotiation. In the WFD mode, before the determination of the roles, the communication apparatus 151 is neither a master station nor a slave station.

Specifically, first, one of the apparatuses that will communicate with each other issues an apparatus search command to search for the other apparatus to be connected in the WFD mode. In a case that the other apparatus as a communication partner is found, both the apparatuses check information regarding a service and a function that can be supplied by the apparatuses. The checking of the information to be supplied by the apparatuses is optional and is not necessarily essential. The phase of checking the information to be supplied by the apparatuses corresponds to, for example, P2P provision discovery. Next, after the checking of the information to be supplied by the apparatuses, a P2P client out of the apparatuses and a P2P group owner out of the apparatuses are determined as the roles. After the client and the group owner are determined, parameters for performing communication via WFD are exchanged between the apparatuses. Based on the exchanged parameters, the P2P client and the P2P group owner perform remaining wireless connection processing and IP connection processing. In the WFD mode, the communication apparatus 151 may necessarily operate as the GO without performing the above-described GO negotiation. That is, the communication apparatus 151 may operate in the WFD mode that is an autonomous GO mode. In addition, a state in which the communication apparatus 151 operates in the WFD mode is, for example, a state in which a connection via WFD is not established but the communication apparatus 151 operates as the GO or a state in which a connection via WFD is established and the communication apparatus 151 operates as the GO.

In the software AP mode, one (e.g., the information processing apparatus 101) of apparatuses (e.g., the information processing apparatus 101 and the communication apparatus 151) that communicate with each other serves as a client that plays a role of requesting various services. The other of the apparatuses implements a function of an access point for Wi-Fi by setting software. The software AP corresponds to a Wi-Fi master station, and the client corresponds to a Wi-Fi slave station. In the software AP mode, the client searches for the apparatus serving as the software AP by using an apparatus search command. In a case that the software AP is found, the client and the software AP perform remaining wireless connection processing (establishment of a wireless connection and the like). Thereafter, the client and the software AP perform IP connection processing (assignment of an IP address and the like). A command and a parameter that are transmitted and received to implement a wireless connection between the client and the software AP may be defined in the Wi-Fi standards and will not be described.

In the present embodiment, in a case where the communication apparatus 151 establishes and maintains the direct connection, the communication apparatus 151 operates as a master station in a network to which the communication apparatus 151 belongs. The master station is an apparatus that builds a wireless network and provides, to a slave station, a parameter to be used for connection to the wireless network. The parameter to be used for connection to the wireless network is a parameter regarding a channel used by the master station. The slave station receives the parameter and uses the channel used by the master station to connect to the wireless network built by the master station. In the direct connection mode, since the communication apparatus 151 operates as the master station, the communication apparatus 151 can determine which frequency band to use for communication in the direct connection mode, and determine which channel to use for communication in the direct connection mode. In the present embodiment, it is assumed that a channel for the 2.4 GHz frequency band and a channel for the 5 GHz frequency band are available for use by the communication apparatus 151 in communication in the direct connection mode. It is assumed that the user can arbitrarily make a setting on the screen illustrated in FIG. 2E to set a frequency band to be used (that is, to set a channel for the frequency band to be used). That is, in a case that the 2.4 GHz frequency band is selected on the screen illustrated in FIG. 2E, the communication apparatus 151 uses a channel for the 2.4 GHz frequency band for communication in the direct connection mode. In a case that the 5 GHz frequency band is selected on the screen illustrated in FIG. 2E, the communication apparatus 151 uses a channel for the 5 GHz frequency band for communication in the direct connection mode. However, in the present embodiment, it is assumed that even when the 5 GHz frequency band is selected on the screen illustrated in FIG. 2E, the communication apparatus 151 does not use a channel for the dynamic frequency selection (DFS) band included in the 5 GHz frequency band for communication in the direct connection mode. In other words, it is assumed that the communication apparatus 151 uses only a channel for a frequency band other than the DFS band included in the 5 GHz frequency band for communication in the direct connection mode. In a case that a radar wave in the DFS frequency band corresponding to a channel for the DFS frequency band is detected in a state in which the channel for the DFS frequency band is used, it is necessary to switch the channel currently used. The DFS band is a frequency band for which a channel may be switched due to the detection of a radar wave. For example, in a case where a wireless chip supporting a DFS function is used or the like, a channel for the dynamic frequency selection (DFS) band included in the 5 GHz frequency band may be usable for communication in the direct connection mode. A channel determined as a channel to be used in the direct connection mode is used for communication via the direct connection. The channel is also used for transmission of a beacon signal as the master station, transmission of a response to a received command, and the like. That is, the channel is used for not only communication processing in the direct connection mode in a state in which the direct connection is established but also communication processing in the direct connection mode in a state in which the direct connection is not established.

Although the user can set whether the channel for the 2.4 GHz frequency band is used or the channel for the 5 GHz frequency band is used, the present embodiment is not limited thereto. The communication apparatus 151 may receive designation of a channel number from the user, and the user may be able to set a channel number of a channel to be used in the direct connection mode. In addition, a channel to be used in the direct connection mode may not be arbitrarily set by the user and may be set in the communication apparatus 151 in advance.

As described above, the communication apparatus 151 may be able to use another frequency band such as the 6.0 GHz frequency band. Therefore, in the present embodiment, the other frequency band may be used in processing in which the 2.4 GHz frequency band or the 5 GHz frequency band is used.

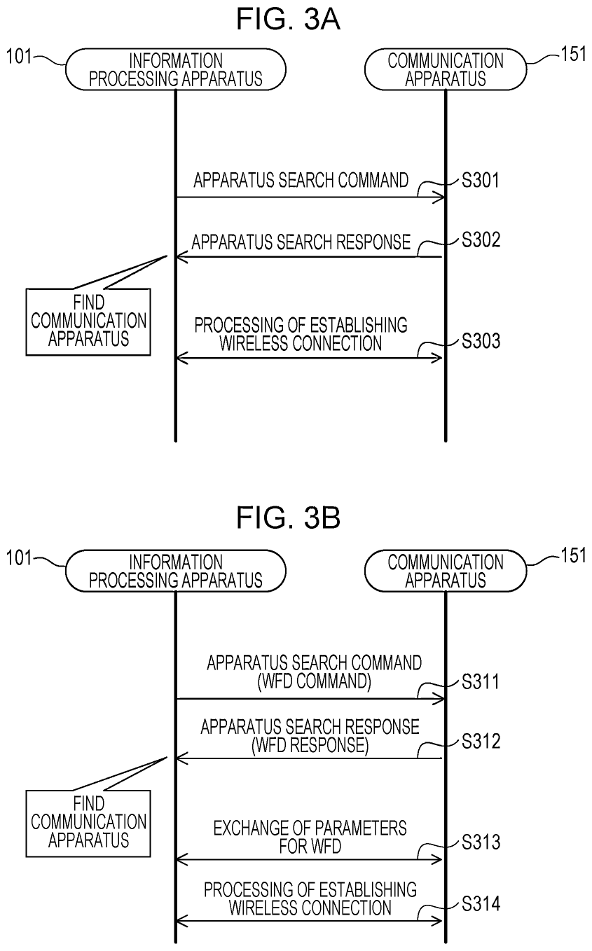

A wireless connection sequence in each of the modes will be described with reference to FIGS. 3A and 3B.

FIG. 3A is a diagram illustrating a wireless connection sequence in the software AP mode. In this wireless connection sequence, processing to be performed by each of the apparatuses is implemented by the CPU included in the apparatus reading various programs stored in a memory, such as the ROM included in the apparatus, into the RAM included in the apparatus and executing the programs. It is assumed that the wireless connection sequence is started in a state in which the information processing apparatus 101 operates as a client and the communication apparatus 151 operates as a software AP and transmits a beacon signal. In a case that the communication apparatus 151 receives, from the user, a predetermined operation for causing the communication apparatus 151 to operate as the software AP, the communication apparatus 151 starts to operate as the software AP. The predetermined operation for causing the communication apparatus 151 to operate as the software AP is, for example, an operation of selecting the “enable/disable direct connection mode” button. This operation corresponds to an operation of activating the direct connection mode.

First, in S301, the information processing apparatus 101 transmits an apparatus search command by sequentially using channels usable by the information processing apparatus 101 and searches for the apparatus that will serve as the software AP.

Subsequently, in S302, in a case that the communication apparatus 151 receives the apparatus search command transmitted from the information processing apparatus 101, the communication apparatus 151 transmits, to the information processing apparatus 101, an apparatus search response that is a response to the apparatus search command. The communication apparatus 151 does not transmit an apparatus search response to an apparatus search command transmitted using a channel other than channels that are available for use by the communication apparatus 151. For example, in a case where a channel that is available for use by the communication apparatus 151 is a fourth channel, the communication apparatus 151 does not transmit an apparatus search response to an apparatus search command transmitted using a first channel. Therefore, in a case where the information processing apparatus 101 transmits the apparatus search command using the first channel and does not receive a response from the communication apparatus 151 for a certain time period or more, the information processing apparatus 101 transmits the apparatus search command using a second channel. The information processing apparatus 101 repeats the above-described operation while incrementing the number of the channel used. For example, in a case that the communication apparatus 151 receives an apparatus search command transmitted by the information processing apparatus 101 using the fourth channel, the communication apparatus 151 transmits an apparatus search response to the information processing apparatus 101. Therefore, the information processing apparatus 101 finds the communication apparatus 151. The channel used for the transmission of the apparatus search response is determined as a channel to be used for communication between the information processing apparatus 101 and the communication apparatus 151. That is, the channel to be used for communication between the information processing apparatus 101 and the communication apparatus 151 is determined by the communication apparatus 151 operating as the software AP.

Subsequently, in S303, known processing of establishing a wireless connection between the information processing apparatus 101 and the communication apparatus 151 is performed. Specifically, processing including transmission of a connection request, authentication of the connection request, and assignment of an IP address is performed. A command and a parameter that are transmitted and received in the processing of establishing the wireless connection between the information processing apparatus 101 and the communication apparatus 151 may be defined in the Wi-Fi standards and will not be described.

FIG. 3B is a diagram illustrating a wireless connection sequence in the WFD mode. In this wireless connection sequence, processing to be performed by each of the apparatuses is implemented by the CPU included in the apparatus reading various programs stored in a memory, such as the ROM included in the apparatus, into the RAM included in the apparatus and executing the programs. It is assumed that the wireless connection sequence is started in a case that a predetermined operation for establishing a connection via WFD is received from the user in a state in which each of the apparatuses activates a predetermined application for executing a WFD feature. The predetermined operation for establishing the connection via WFD is, for example, an operation of selecting the “enable/disable direct connection mode” button. The operation corresponds to an operation for activating the direct connection mode.

First, in S311, the information processing apparatus 101 transmits an apparatus search command and searches for an apparatus supporting the WFD feature as a communication partner apparatus.

Subsequently, in S312, in a case that the received apparatus search command is a command transmitted using the same channel as a channel currently used by the communication apparatus 151 in the direct connection mode, the communication apparatus 151 transmits, to the information processing apparatus 101, an apparatus search response that is a response to the apparatus search command. Therefore, the information processing apparatus 101 finds the communication apparatus 151 as an apparatus supporting the WFD feature. After the information processing apparatus 101 finds the communication apparatus 151, processing of exchanging information regarding a service and a function that can be supplied by the information processing apparatus 101 and the communication apparatus 151 may be performed by the information processing apparatus 101 and the communication apparatus 151.

Subsequently, in S313, the GO negotiation is performed between the information processing apparatus 101 and the communication apparatus 151. After the client and the group owner are determined, parameters for performing communication via WFD are exchanged between the information processing apparatus 101 and the communication apparatus 151. Based on the exchanged parameters, the P2P client and the group owner perform remaining wireless connection processing and IP connection processing. As described above, the communication apparatus 151 may operate in the autonomous GO mode, the GO negotiation may be omitted, and the communication apparatus 151 may necessarily operate as the GO. In a case that the communication apparatus 151 operates as the GO, the communication apparatus 151 determines a frequency band and a channel that are used for communication via WFD as the master station. Therefore, the communication apparatus 151 operating as the GO can select which frequency band to use out of the 5 GHz frequency band and the 2.4 GHz frequency band, and can select which channel to use out of channels for the determined frequency band.

Subsequently, in S314, the information processing apparatus 101 and the communication apparatus 151 perform processing of establishing a wireless connection using the channel determined by the GO based on the exchanged parameters.

### Regarding Infrastructure Connection Method

In the infrastructure connection, apparatuses (e.g., the information processing apparatus 101 and the communication apparatus 151) that communicate with each other are connected to an access point (e.g., the access point 131) that controls a network to which the apparatuses belong, and communicate with each other via the access point. In the present embodiment, the connections to the access point correspond to connections to the network formed by the access point. The communication apparatus 151 can operate in the mode (infrastructure connection mode) for communication via the infrastructure connection as one of connection modes.

In the infrastructure connection, each of the apparatuses searches for the access point using an apparatus search command. In the present embodiment, the search for the access point corresponds to a search for the network formed by the access point. In a case that the access point is found, the apparatuses and the access point perform remaining wireless connection processing (establishment of a wireless connection and the like). Thereafter, the apparatuses and the access point perform IP connection processing (assignment of an IP address and the like). A command and a parameter that are transmitted and received to implement the wireless connection between the apparatuses and the access point may be defined in the Wi-Fi standards and will not be described.

In the present embodiment, in a case that the communication apparatus 151 operates in a state in which the communication apparatus 151 establishes the infrastructure connection, the access point 131 operates as a master station and the communication apparatus 151 operates as a slave station. That is, in the present embodiment, the infrastructure connection indicates a connection between the communication apparatus 151 operating as the slave station and the apparatus operating as the master station. In a case that the communication apparatus 151 establishes the infrastructure connection and the information processing apparatus 101 establishes an infrastructure connection to the access point 131, the communication apparatus 151 and the information processing apparatus 101 can communicate with each other via the access point 131. Since a channel used for communication via the infrastructure connection is determined by the access point 131, the communication apparatus 151 uses the channel determined by the access point 131 to perform communication via the infrastructure connection. In the present embodiment, it is assumed that a channel for the 2.4 GHz frequency band and a channel for the 5 GHz frequency band are available for use by the communication apparatus 151 in the communication via the infrastructure connection. A channel for the DFS band included in the 5 GHz frequency band is available for use by the communication apparatus 151 in the communication via the infrastructure connection. To communicate with the communication apparatus 151 via the access point 131, the information processing apparatus 101 needs to recognize that the communication apparatus 151 belongs to the network that is formed by the access point 131 and to which the information processing apparatus 101 belongs.

In the present embodiment, the communication apparatus 151 can concurrently establish both the direct connection and the infrastructure connection. In other words, the communication apparatus 151 can concurrently establish both a Wi-Fi connection in which the communication apparatus 151 operates as a slave station and a Wi-Fi connection in which the communication apparatus 151 operates as a master station. The operation of the communication apparatus 151 in a state in which the above-described two connections are concurrently established is referred to as a concurrent operation.

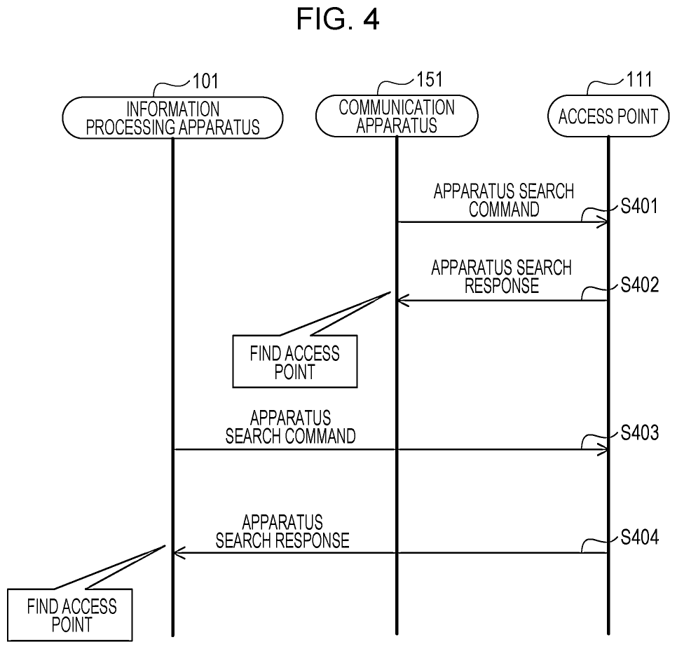

FIG. 4 is a diagram illustrating a wireless connection sequence in the infrastructure connection mode. In this wireless connection sequence, processing to be performed by each of the apparatuses is implemented by the CPU included in the apparatus reading various programs stored in a memory, such as the ROM included in the apparatus, into the RAM included in the apparatus and executing the programs. In a case that the communication apparatus 151 receives, from the user, a predetermined operation for causing the communication apparatus 151 to operate in the infrastructure connection mode, the communication apparatus 151 starts to operate in the infrastructure connection mode. The predetermined operation for causing the communication apparatus 151 to operate in the infrastructure connection mode is, for example, an operation of selecting the “select access point for connection” button.

First, in S401, the communication apparatus 151 transmits an apparatus search command by sequentially using the channels usable by the communication apparatus 151 and searches for an access point present around the communication apparatus 151.

Subsequently, in S402, in a case that the access point 131 receives the apparatus search command transmitted from the communication apparatus 151, the access point 131 transmits, to the communication apparatus 151, an apparatus search response that is a response to the apparatus search command. The access point 131 transmits only an apparatus search response to an apparatus search command transmitted using a channel usable by the access point 131.

Therefore, the communication apparatus 151 can find the access point 131. A channel used for the transmission of the apparatus search response is determined as a channel to be used for communication between the communication apparatus 151 and the access point 131. That is, the channel to be used for communication in the infrastructure connection mode is determined by the access point 131. Thereafter, the communication apparatus 151 displays a list of one or more found access points and receives selection from the user. In this case, it is assumed that the access point 131 is selected.

Thereafter, known processing of establishing a wireless connection between the communication apparatus 151 and the access point 131 selected by the user is performed. Specifically, processing including transmission of a connection request, authentication of the connection request, assignment of an IP address is performed. Similarly to a P2P mode, a command and a parameter that are transmitted and received in the processing of establishing the wireless connection between the access point 131 and the communication apparatus 151 may be defined in the Wi-Fi standards and will not be described.

In S403 and S404, processing that is the same as or similar to that in S401 and S402 is performed by the information processing apparatus 101 and the access point 131. In this case, the access point 131 transmits, to the information processing apparatus 101, an apparatus search response using a channel used for communication with the communication apparatus 151. That is, the access point 131 communicates with the communication apparatus 151 and the information processing apparatus 101 by using the same channel.

Therefore, the communication apparatus 151 and the information processing apparatus 101 are connected to each other via the access point 131 and can communicate with each other via the access point 131.

### Process to be Performed by Wi-Fi Agile Multiband

As described above, the communication apparatus 151 according to the present embodiment supports Wi-Fi Agile Multiband. Wi-Fi Agile Multiband is a feature that is compliant with the IEEE802.11v, IEEE802.11r, and IEEE802.11k standards and controls to connect the communication apparatus 151 to an appropriate network according to the state of the network present around the communication apparatus 151.

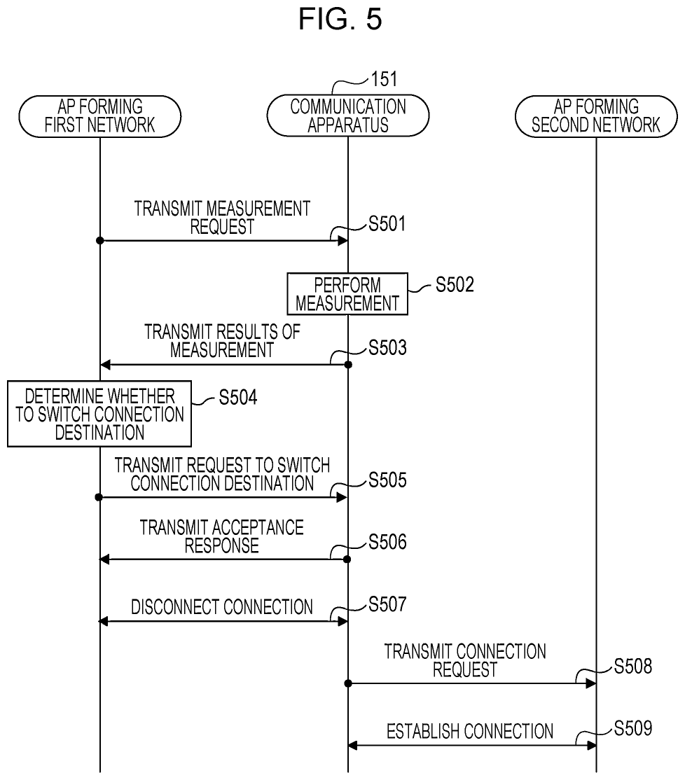

FIG. 5 is a sequence diagram illustrating a process to be performed by Wi-Fi Agile Multiband. In this sequence, processing to be performed by each of the apparatuses is implemented by the CPU included in the apparatus reading various programs stored in a memory, such as the ROM included in the apparatus, into the RAM included in the apparatus and executing the programs. In the description of FIG. 5, it is assumed that a first network to which the communication apparatus 151 is currently connected and a second network to which the communication apparatus 151 is not currently connected are present around the communication apparatus 151. An access point forming the first network is, for example, the access point 131. The access point forming the first network may be the same as or different from an access point forming the second network. In a case where the access point forming the first network is the same as the access point forming the second network, for example, a frequency band used in the first network is different from a frequency band used in the second network. It is assumed that the process illustrated in FIG. 5 is started in a state in which the communication apparatus 151 operates in the infrastructure connection mode and is connected to the first network. In addition, in a state in which the connection between the communication apparatus 151 and the access point forming the first network is established, the access point forming the first network acquires information indicating whether the communication apparatus 151 supports IEEE802.11v. It is assumed that in a case that the access point forming the first network identifies, based on the acquired information, that the communication apparatus 151 supports IEEE802.11v, the following processing is performed. That is, in order words, the information indicating whether the communication apparatus 151 supports IEEE802.11v indicates whether the communication apparatus 151 supports Wi-Fi Agile Multiband. In addition, it is assumed that the process described below is implemented by the access point forming the first network and the Wi-Fi Agile Multiband feature included in the communication apparatus 151.

In S501, the access point forming the first network transmits a measurement request to the communication apparatus 151. A system defined in the IEEE802.11k standard is used for the transmission of the measurement request.

In S502, the communication apparatus 151 starts to measure a value regarding one or more networks present around the communication apparatus 151 based on the measurement request received in S501. The value regarding the one or more networks present around the communication apparatus 151 is specifically the strength of a radio wave of information received by the communication apparatus 151. Specifically, the information received by the communication apparatus 151 corresponds to the one or more networks present around the communication apparatus 151 and is transmitted by an access point forming the one or more networks around the communication apparatus 151. The information may be a beacon or a frame. In a case where a plurality of networks are present around the communication apparatus 151, the strength of radio waves of information corresponding to the plurality of networks is measured by the communication apparatus 151. In this case, it is assumed that the strength of a radio wave of information corresponding to the first network and transmitted from the access point forming the first network, and the strength of a radio wave of information corresponding to the second network and transmitted from the access point forming the second network are measured by the communication apparatus 151. In this processing, the information acquired by the communication apparatus 151 is not limited to the information regarding the strength of the radio waves of the information received by the communication apparatus 151. For example, an SSID that is identification information of the one or more networks corresponding the information received by the communication apparatus 151, information regarding a frequency band used in the one or more networks, information regarding the number of apparatuses connected to the one or more networks, and the like may be acquired by the communication apparatus 151.

In S503, the communication apparatus 151 specifies and extracts information that is included in the information acquired in S502 and corresponds to a network having an SSID identical to the SSID of the first network. The communication apparatus 151 transmits, to the access point forming the first network, the extracted information included in the information acquired in S502 as a response to the request received in S501, and does not transmit information that is included in the information acquired in S502 and is not extracted to the access point forming the first network. In this case, it is assumed that the SSID of the first network is identical to the SSID of the second network and that information corresponding to the second network is transmitted to at least the access point forming the first network.

In S504, the access point forming the first network determines, based on the information received from the communication apparatus 151, whether to switch (change) the destination to which the communication apparatus 151 is connected from the first network to another network. This determination is processing of determining whether communication between the other network and the communication apparatus 151 is stabler than communication between the first network and the communication apparatus 151. In addition, the access point forming the first network performs the determination by comprehensively referring to radio wave strength and a frequency band specified based on the information received from the communication apparatus 151, the number of apparatuses connected to each of the networks, and the like. In the determination, the access point forming the first network may refer to information other than the information received from the communication apparatus 151. The information other than the information received from the communication apparatus 151 is, for example, collected by the access point forming the first network and includes information regarding the number of apparatuses connected to the access point forming the first network, the amount and speed of data communicated on the first network, and the like.

In a case that the access point forming the first network determines that the destination to which the communication apparatus 151 is connected is switched from the first network to the other network, the access point forming the first network specifies a new destination to which the communication apparatus 151 will be connected. In this case, a network that is specified based on the information received from the communication apparatus 151 and is any of networks present around the communication apparatus 151 is specified as the new destination to which the communication apparatus 151 will be connected. The network that is specified by the Wi-Fi Agile Multiband feature as the new destination to which the communication apparatus 151 will be connected is referred to as a switching target network. In the description, it is assumed that the switching target network is the second network. Next, the access point forming the first network specifies information regarding the second network. Specifically, the information regarding the second network is, for example, the SSID of the second network, a frequency band used in the second network, and a channel used in the second network. The access point forming the first network may specify a plurality of networks as new destinations to which the communication apparatus 151 will be connected, and may specify information regarding each of the networks.

In S505, the access point forming the first network transmits, to the communication apparatus 151, a request to switch the destination to which the communication apparatus 151 is connected. The request to switch the destination to which the communication apparatus 151 is connected includes information regarding the network specified in S504 as the new destination to which the communication apparatus 151 will be connected. The request to switch the destination to which the communication apparatus 151 is connected is transmitted as a BSS Transition Management (BTM) request by a BTM frame defined in the IEEE802.11v standard.

In S506, in a case that the communication apparatus 151 follows the request that has been received in S505 and is to switch the connection destination, the communication apparatus 151 transmits, to the access point forming the first network, a response (acceptance response) indicating that the communication apparatus 151 accepts the switching of the destination to which the communication apparatus 151 is connected. In a case that the communication apparatus 151 does not follow the request that has been received in S505 and is to switch the connection destination, the communication apparatus 151 may transmit, to the access point forming the first network, a response indicating that the communication apparatus 151 refuses the switching of the destination to which the communication apparatus 151 is connected. In the description, it is assumed that the communication apparatus 151 transmits a response indicating that the communication apparatus 151 accepts the switching of the destination to which the communication apparatus 151 is connected. Each of the responses is transmitted as a BTM response.

In S507, the communication apparatus 151 disconnects the connection to the first network.

In S508, the communication apparatus 151 transmits, to the access point forming the second network, a request to connect to the second network. It is assumed that a password that is used to connect the communication apparatus 151 to the second network and is transmitted from the communication apparatus 151 to the access point forming the second network is identical to a password used for the connection of the communication apparatus 151 to the first network. That is, after the communication apparatus 151 is disconnected from the first network, the communication apparatus 151 can identify the password to be used for connection to the second network without receiving input of the password for connection to the second network from the user and receiving the password from another apparatus.

In S509, the connection between the communication apparatus 151 and the second network is established.

As described above, a network as a destination to which the communication apparatus 151 is connected can be appropriately controlled by the function that is Wi-Fi Agile Multiband.

### Arrangement of Channels for Wi-Fi

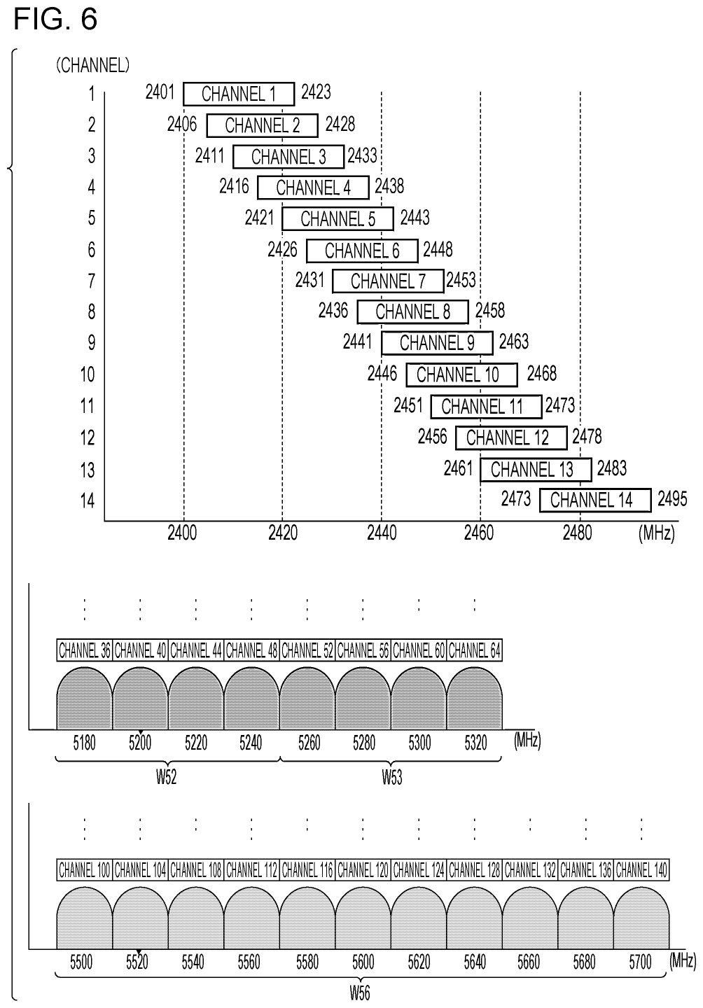

FIG. 6 illustrates the arrangement of channels for the 2.4 GHz frequency band and channels for the 5 GHz frequency band. For Wi-Fi, the 2.4 GHz frequency band is used by dividing the 2.4 GHz frequency band into bandwidths of 22 MHz. Numbers are assigned to the channels. The channels for the 2.4 GHz frequency band are channels 1 to 14. In addition, the 5 GHz frequency band is used by dividing the 5 GHz frequency band into bandwidths of 20 MHz. Frequencies in the channels do not overlap. Channels for frequency bands that are included in the 5 GHz frequency band and are not the DFS band are channels called W52. Specifically, W52 corresponds to channels 36, 40, 44, and 48. Channels for the DFS band included in the 5 GHz frequency band are channels called W53 and W56. Specifically, W53 corresponds to channels 52, 56, 60, and 64. W56 corresponds to channels 100, 104, 108, 112, 116, 120, 124, 128, 132, 136, and 140.

As described above, in the present embodiment, the communication apparatus 151 can perform the concurrent operation in which the communication apparatus 151 concurrently operates in the infrastructure connection mode and in the direct connection mode. In this case, in a case that a channel used in the infrastructure connection mode is the same as a channel used in the direct connection mode, radio wave interference may occur in the communication in each of the infrastructure connection mode and the direct connection mode. In addition, even in such a case, for example, the DRCS function may control to suppress the occurrence of radio wave interference between the infrastructure connection and the direct connection established by the communication apparatus 151. However, even in this case, communication between an access point to which the communication apparatus 151 is connected via the infrastructure connection and another apparatus may interfere with communication of the communication apparatus 151 in the direct connection mode.

As described above, a destination to which the communication apparatus 151 is connected may be switched by Wi-Fi Agile Multiband. In a case that the switching of the destination to which the communication apparatus 151 is connected is performed by Wi-Fi Agile Multiband in a state in which the communication apparatus 151 performs the concurrent operation, and a channel used for connection between the communication apparatus 151 and a new destination to which the communication apparatus 151 is connected is a channel used by the communication apparatus 151 in the direct connection mode, a channel used by the communication apparatus 151 in the infrastructure connection mode is the same as the channel used by the communication apparatus 151 in the direct connection mode. That is, in a case that the destination to which the communication apparatus 151 is connected is switched by Wi-Fi Agile Multiband, the communication apparatus 151 may transition to a connection state in which radio wave interference may occur due to the switching of the destination to which the communication apparatus 151 is connected.

Therefore, in the present embodiment, control for solving the above-described problems is performed.

### Control When Direct Connection Mode is to be Newly Activated

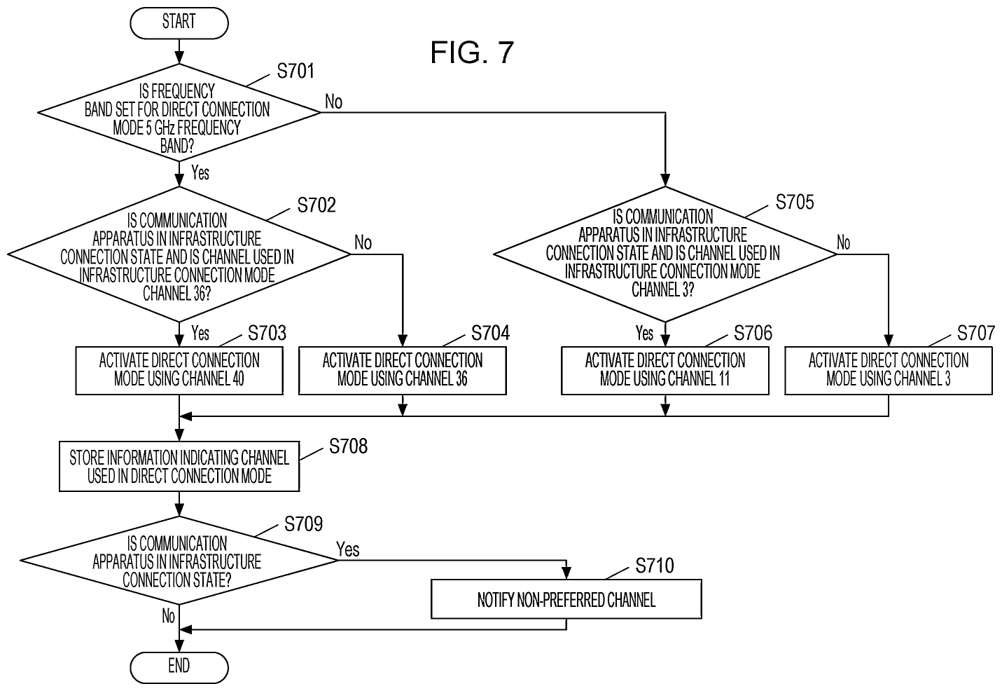

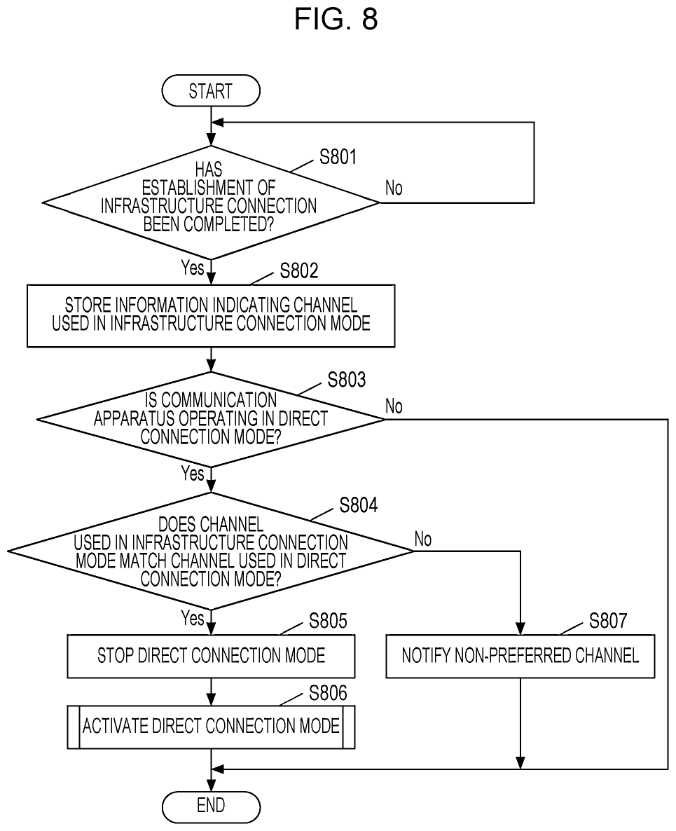

FIG. 7 is a flowchart illustrating a process to be performed by the communication apparatus 151 according to the present embodiment. In this flowchart, processing to be performed by the communication apparatus 151 is implemented by the CPU 154 reading various programs stored in a memory such as the ROM 152 into the RAM 153 and executing the programs. It is assumed that the process illustrated in FIG. 7 is started in a case that processing as a trigger for activating the direct connection mode is performed, for example, in a case that the communication apparatus 151 receives, from the user, the operation for activating the direct connection mode described above. The processing as the trigger for activating the direct connection mode is reception of an operation for activating the direct connection mode on the screen illustrated in FIG. 2C, and, for example, processing performed in processes illustrated in FIGS. 8, 9, and 10. Specifically, for example, the processing is processing of stopping the direct connection mode by newly establishing an infrastructure connection in a state in which the communication apparatus 151 operates in the direct connection mode. In addition, in the present embodiment, it is assumed that the communication apparatus 151 has a function of restarting to operate in a communication mode in which the communication apparatus 151 operates immediately before being powered off when the communication apparatus 151 is powered on. Therefore, the processing as the trigger for activating the direct connection mode is, for example, processing of receiving a power-on operation after the communication apparatus 151 is powered off in a state in which the communication apparatus 151 operates in the direct connection mode. In the present embodiment, in a case that the communication apparatus 151 performs the concurrent operation immediately before the communication apparatus 151 is powered off, and the communication apparatus 151 is powered off and powered on, the communication apparatus 151 starts to operate in the infrastructure connection mode and performs processing of reconnecting to the access point. The communication apparatus 151 starts to operate in the direct connection mode based on the start of the reconnection processing. In this case, the communication apparatus 151 may start to operate in the direct connection mode based on the fact that a predetermined time elapses after the reconnection processing is started. In addition, the communication apparatus 151 may start to operate in the direct connection mode based on the fact that the communication apparatus 151 is connected to the access point by the reconnection processing or based on the fact that the connection of the communication apparatus 151 to the access point by the reconnection processing is not established and time-out occurs.

In S701, the CPU 154 determines whether a frequency band set on the screen illustrated in FIG. 2E is the 5 GHz frequency band as a frequency band to be used in the direct connection mode. In a case where the result of the determination in S701 is YES, the CPU 154 proceeds to S702. In a case where the 2.4 GHz frequency band is set and the result of the determination in S701 is NO, the CPU 154 proceeds to S705.

In S702, the CPU 154 determines whether the communication apparatus 151 is in an infrastructure connection state.

In a case that the communication apparatus 151 is in the infrastructure connection state, the CPU 154 specifies a channel used in the infrastructure connection mode and determines whether the channel used in the infrastructure connection mode is the channel 36. That is, in this processing, the CPU 154 determines whether the communication apparatus 151 is in the infrastructure connection state, and determines whether the channel used in the infrastructure connection mode is the channel 36. The infrastructure connection state is a state in which the communication apparatus 151 operates in the infrastructure connection mode and is connected to the access point 131. The specified channel corresponds to a channel used in the infrastructure connection mode when the processing as the trigger for activating the direct connection mode is performed. In a case where the result of the determination in S702 is YES, the CPU 154 proceeds to S703. On the other hand, in a case that the communication apparatus 151 is not connected to the access point 131 and is not in the infrastructure connection state, or in a case that the communication apparatus 151 is in the infrastructure connection state but the channel used in the infrastructure connection mode is not the channel 36, the CPU 154 proceeds to S704. A case where the communication apparatus 151 is in the infrastructure connection mode corresponds a case where the communication apparatus 151 operates in the infrastructure connection mode (in the infrastructure connection state) and an operation for activating the direct connection mode is performed on the communication apparatus 151.

In S703, the CPU 154 sets the channel 40 as a channel to be used in the direct connection mode and activates the direct connection mode. Specifically, for example, the CPU 154 causes the communication apparatus 151 to operate in the software AP mode in which the channel 40 is used or in the WFD mode in which the channel 40 is used. Therefore, the communication apparatus 151 concurrently operates both in the infrastructure connection mode in which the channel 36 is used and in the direct connection mode in which the channel 40 is used. In a case that the communication apparatus 151 starts to operate in the direct connection mode, the communication apparatus 151 can perform the sequences described with reference to FIGS. 3A and 3B and establish a direct connection to another apparatus. After S703, the CPU 154 proceeds to S708.

In S704, the CPU 154 sets the channel 36 as a channel to be used in the direct connection mode and activates the direct connection mode. Specifically, for example, the CPU 154 causes the communication apparatus 151 to operate in the software AP mode in which the channel 36 is used or in the WFD mode in which the channel 36 is used. Therefore, the communication apparatus 151 concurrently operates both in the infrastructure connection mode in which a channel other than the channel 36 is used and in the direct connection mode in which the channel 36 is used. Alternatively, for example, the communication apparatus 151 operates only in the direct connection mode in which the channel 36 is used. After S704, the CPU 154 proceeds to S708.

In S705, the CPU 154 determines whether the communication apparatus 151 is in the infrastructure connection state. In a case that the communication apparatus 151 is in the infrastructure connection state, the CPU 154 specified a channel used in the infrastructure connection mode and determines whether the channel used in the infrastructure connection mode is the channel 3. That is, in this processing, the CPU 154 determines whether the communication apparatus 151 is in the infrastructure connection state, and determines whether the channel used in the infrastructure connection mode is the channel 3. The channel specified in this case corresponds to a channel used in the infrastructure connection mode when the processing as the trigger for activating the direct connection mode is performed. In a case where the result of the determination in S705 is YES, the CPU 154 proceeds to S706. On the other hand, in a case where the communication apparatus 151 is not connected to the access point 131 and is not in the infrastructure connection state, or in a case where the communication apparatus 151 is in the infrastructure connection state but the channel used in the infrastructure connection state is not the channel 3, the CPU 154 proceeds to S707.

In S706, the CPU 154 sets the channel 11 as a channel to be used in the direct connection mode and activates the direct connection mode. Specifically, for example, the CPU 154 causes the communication apparatus 151 to operate in the software AP mode in which the channel 11 is used or in the WFD mode in which the channel 11 is used. Therefore, the communication apparatus 151 concurrently operates both in the infrastructure connection mode in which the channel 3 is used and in the direct connection mode in which the channel 11 is used. After S706, the CPU 154 proceeds to S708.

In S707, the CPU 154 sets the channel 3 as a channel to be used in the direct connection mode and activates the direct connection mode. Specifically, for example, the CPU 154 causes the communication apparatus 151 to operate in the software AP mode in which the channel 3 is used or the WFD mode in which the channel 3 is used. Therefore, for example, the communication apparatus 151 concurrently operates both in the infrastructure connection mode in which a channel other than the channel 3 is used and in the direct connection mode in which the channel 3 is used. Alternatively, for example, the communication apparatus 151 operates only in the direct connection mode in which the channel 3 is used. After S707, the CPU 154 proceeds to S708.

In S708, the CPU 154 specifies a channel currently used in the direct connection mode and stores information indicating the specified channel to a predetermined storage region in any of the memories included in the communication apparatus 151. The specified channel is used as a non-preferred channel described later. Specifically, for example, in a case that the CPU 154 performs S708 after S703, the CPU 154 stores information indicating the channel 40 to the predetermined storage region.

In S709, the CPU 154 determines whether the communication apparatus 151 is in the infrastructure connection state. In a case where the result of the determination in S709 is YES, the CPU 154 proceeds to S710. In a case where the result of the determination in S709 is NO, the CPU 154 ends the process. In a case where the result of the determination in S709 is YES, the CPU 154 may determine whether an access point forming a network to which the communication apparatus 151 is connected supports the Wi-Fi Agile Multiband feature before proceeding to S710.

In a case where the result of the determination in S709 is YES, the CPU 154 proceeds to S710. In a case where the result of the determination in S709 is NO, the CPU 154 ends the process.

In S710, the CPU 154 controls to prevent a network to which the communication apparatus 151 is connected in the infrastructure connection mode from being switched by Wi-Fi Agile Multiband to a network in which a channel currently used by the communication apparatus 151 in the direct connection mode is used. Specifically, the CPU 154 controls to prevent the network in which the channel currently used by the communication apparatus 151 in the direct connection mode is used from being specified as a switching target network in the access point forming the network to which the communication apparatus 151 is connected. More Specifically, the CPU 154 transmits, to the access point forming the network to which the communication apparatus 151 is connected, information indicating the channel currently used by the communication apparatus 151 in the direct connection mode. The information is, for example, a BSS Transmission Management (BTM) request frame defined in the IEEE802.11v standard, and includes the number of the channel currently used by the communication apparatus 151 in the direct connection mode in a non-preferred channel designation field. The channel indicated by the transmitted information is a non-preferred channel. The access point that received the information indicating the non-preferred channel controls to prevent the network in which the non-preferred channel is used from being specified as a switching target network. Therefore, the CPU 154 controls the communication apparatus 151 such that the network to which the communication apparatus 151 is connected in the infrastructure connection mode is not switched by Wi-Fi Agile Multiband to the network in which the channel currently used by the communication apparatus 151 in the direct connection mode is used.

Since the above-described process is performed, in a case that an operation for activating the direct connection mode is performed on the communication apparatus 151 in a state in which the communication apparatus 151 operates in the infrastructure connection mode, a channel used in the infrastructure connection mode can be different from a channel used in the direct connection mode by the above-described processing. Therefore, it is possible to suppress the occurrence of interference in the communication in the infrastructure connection mode and the communication in the direct connection mode.

In S703, S704, S706, and S707, the channels determined as the channels to be used are not limited to the above-described channels. As long as channels are determined such that the channel used in the infrastructure connection mode does not match the channel used in the direct connection mode, channels different from the above-described channels may be determined as channels to be used. Specifically, for example, in S703, the channel 44 or the channel 48 may be set as a channel to be used in the direct connection mode. In this case, a channel other than the channels for the DFS band is preferably set.

In the above description, in a case that a frequency band set on the screen illustrated in FIG. 2E as a frequency band to be used in the direct connection mode is the 5 GHz frequency band, the channel 36 is used preferentially over the channel 40. In addition, in the above description, in a case that a frequency band set on the screen illustrated in FIG. 2E as a frequency band to be used in the direct connection mode is the 2.4 GHz frequency band, the channel 3 is used preferentially over the channel 11. However, the present embodiment is not limited thereto. The channels to be preferentially used may be other channels.

The CPU 154 may perform processing partially different from the above-described processing such that the channel used in the infrastructure connection mode does not match the channel used in the direct connection mode. For example, instead of the processing in S702, the CPU 154 may determine only whether the communication apparatus 151 is in the infrastructure connection state. In a case where the CPU 154 determines that the communication apparatus 151 is in the infrastructure connection mode, the CPU 154 may specify the channel used in the infrastructure connection mode and specify any of channels different from the channel used in the infrastructure connection mode among the plurality of channels for the 5 GHz frequency band that are usable by the communication apparatus 151. Thereafter, the CPU 154 may set the specified channel as a channel to be used in the direct connection mode and activate the direct connection mode. In this case, the channel preferentially specified may be set in advance. Specifically, for example, the channel 36 may be preferentially specified as a channel to be used in the direct connection mode. Similarly, for example, instead of the processing in S705, the CPU 154 may determine whether the communication apparatus 151 is in the infrastructure connection state. In a case where the CPU 154 determines that the communication apparatus 151 is in the infrastructure connection state, the CPU 154 may specify the channel used in the infrastructure connection mode and specify any of channels different from the channel used in the infrastructure connection mode among the plurality of channels for the 2.4 frequency band that are usable by the communication apparatus 151. Thereafter, the CPU 154 may set the specified channel as a channel to be used in the direct connection mode and activate the direct connection mode. In this case, the channel preferentially specified may be set in advance. Specifically, for example, the channel 11 may be preferentially specified as a channel to be used in the direct connection mode.

Although the case where the WFD mode is the autonomous GO mode is described above, the processing may be performed at a time different from that described above in a mode in which the GO negotiation is performed instead of the autonomous GO mode. That is, the process illustrated in FIG. 7 may not be started in a case that the processing as the trigger for activating the direct connection mode is performed. Specifically, the communication apparatus 151 receives a WFD apparatus search command from the information processing apparatus 101 and perform the GO negotiation, and the process illustrated in FIG. 7 may be started in a case that it is determined that the communication apparatus 151 operates as the GO.

### Control When Infrastructure Connection Mode is to be Newly Activated

FIG. 8 is a flowchart illustrating a process to be performed by the communication apparatus 151 in the present embodiment. In this flowchart, processing to be performed by the communication apparatus 151 is implemented by the CPU 154 reading various programs stored in a memory such as the ROM 152 into the RAM 153 and executing the programs. It is assumed that the process illustrated in FIG. 8 is started in a case that processing as a trigger for activating the infrastructure connection mode is performed and the communication apparatus 151 tries to establish a connection to the access point 131 as described with reference to FIG. 4. The processing as the trigger for activating the infrastructure connection mode is, for example, processing in which the communication apparatus 151 receives, from the user, the above-described operation for activating the infrastructure connection mode. In addition, the processing as the trigger for activating the infrastructure connection mode is, for example, processing in which the communication apparatus 151 receives a power-on operation after the communication apparatus 151 is powered off in a state in which the communication apparatus 151 operates in the infrastructure connection mode.

In S801, the CPU 154 determines whether the establishment of an infrastructure connection (i.e., a connection between the communication apparatus 151 and the access point 131) by the communication apparatus 151 has been completed. In a case where the result of the determination in S801 is YES, the CPU 154 proceeds to S802. In a case where the result of the determination in S801 is NO, the CPU 154 repeats S801 until the establishment of the infrastructure connection is completed.

In S802, the CPU 154 stores information indicating which channel is being used in the infrastructure connection mode to any of the memories included in the communication apparatus 151. As described above, since the channel used in the infrastructure connection is determined by the access point 131, the channel indicated by the information stored in this case is the channel determined by the access point 131.

In S803, the CPU 154 determines whether the communication apparatus 151 is operating in the direct connection mode. A case where the result of the determination in S803 is YES corresponds to a case where an operation for activating the infrastructure connection mode is performed on the communication apparatus 151 in a state in which the communication apparatus 151 operates in the direct connection mode. A case where the result of the determination in S803 is NO corresponds to a case where an operation for activating the infrastructure connection mode is performed on the communication apparatus 151 in a state in which the communication apparatus 151 does not operate in the direct connection mode. The state in which the communication apparatus 151 operates in the direct connection mode includes a state in which the communication apparatus 151 operates in the direct connection mode but the direct connection by the communication apparatus 151 is not established. The state in which the communication apparatus 151 operates in the direct connection mode also includes a state in which the communication apparatus 151 operates in the direct connection mode and the direct connection by the communication apparatus 151 is established. The state in which the communication apparatus 151 operates in the direct connection mode but the direct connection by the communication apparatus 151 is not established is a state in which the communication apparatus 151 operates as the GO or the software AP but a direct connection between the communication apparatus 151 and another apparatus is not established. In a case where the result of the determination in S803 is YES, the CPU 154 proceeds to S804. In a case where the result of the determination in S803 is NO, the CPU 154 ends the process while causing the communication apparatus 151 to operate in only the infrastructure connection mode.

In S804, the CPU 154 determines whether the channel currently used in the infrastructure connection mode matches a channel currently used in the direct connection mode. The channel currently used in the infrastructure connection mode is indicated by the information stored in the S802. In a case where the result of the determination in S804 is YES, the CPU 154 proceeds to S805. In a case where the result of the determination in S804 is NO, the CPU 154 proceeds to S807 while causing the communication apparatus 151 to concurrently operate both in the infrastructure connection mode and in the direct connection mode without disconnecting the direct connection and stopping the direct connection mode.

In S805, the CPU 154 stops the operation of the communication apparatus 151 in the direct connection mode. Therefore, in a case that the communication apparatus 151 has established the direct connection, the direct connection is disconnected.

In S806, the CPU 154 reactivates the direct connection mode. That is, the CPU 154 performs the process indicated in the flowchart of FIG. 7. Therefore, the direct connection mode is newly activated in a state in which the communication apparatus 151 operates in the infrastructure connection mode. In this case, as described with reference to FIG. 7, CPU 154 controls the communication apparatus 151 such that a channel different from the channel currently used in the infrastructure connection mode is used in the newly activated direct connection mode.

Since the processing in S801 to S806 is performed, the channel used in the infrastructure connection mode can be different from the channel used in the direct connection mode in a case that the operation for activating the infrastructure connection mode is performed on the communication apparatus 151 in a state in which the communication apparatus 151 operates in the direct connection mode. Thereafter, the CPU 154 ends the process. During the processing in S806 performed in this case, the processing in S710 may be performed.

In S807, the CPU 154 controls to prevent a network to which the communication apparatus 151 is connected in the infrastructure connection mode from being switched by Wi-Fi Agile Multiband to a network in which the channel currently used by the communication apparatus 151 in the direct connection mode is used. The processing in S807 is the same as or similar to the processing in S710.

Before proceeding to S807, the CPU 154 may determine whether the access point forming the network to which the communication apparatus 151 is connected supports the Wi-Fi Agile Multiband feature. In a case where the result of the determination is YES, the CPU 154 may proceed to S807. In a case where the result of the determination is NO, the CPU 154 may end the process.

Since the above-described process is performed, the communication can be continued while the channel used in the infrastructure connection mode is different from the channel used in the direct connection mode. Therefore, it is possible to suppress the occurrence of interference in the communication in the infrastructure connection mode and the communication in the direct connection mode.

In the above description, the processing in S802 to S807 is performed after the completion of the establishment of the infrastructure connection. However, the present embodiment is not limited thereto. For example, after it is specified that an infrastructure connection is to be newly established and before the establishment of the infrastructure connection is completed, the processing in S802 to S807 may be performed. After it is specified that the infrastructure connection is to be newly established and before the establishment of the infrastructure connection is completed is after it is specified that the infrastructure connection is to be newly established and before a connection request is transmitted to the access point. In this case, the information stored in S802 is not information of a channel currently used for the infrastructure connection and is information of a channel to be used for the infrastructure connection to be newly established. After the processing in S806 and S807 is completed, the infrastructure connection is newly established.

Control when Channel Used in Infrastructure Connection Mode is Switched During Concurrent Operation

As described above, a channel to be used in the infrastructure connection mode is determined by the access point 131. Therefore, in a case that a channel used by the access point 131 is switched due to control for avoiding congestion or by the user changing a setting for the access point 131, the communication apparatus 151 needs to switch the channel used in the infrastructure connection mode. Control when the channel used in the infrastructure connection mode is switched during the concurrent operation will be described below.

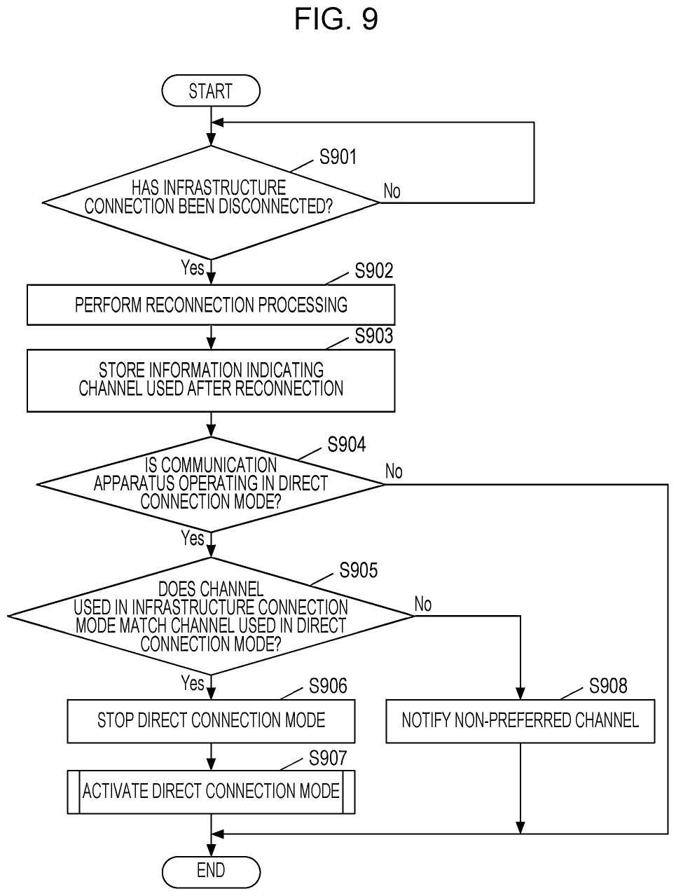

FIG. 9 is a flowchart illustrating a process to be performed by the communication apparatus 151 in the present embodiment. In this flowchart, the process to be performed by the communication apparatus 151 is implemented by the CPU 154 reading various programs stored in a memory such as the ROM 152 into the RAM 153 and executing the programs. This process illustrated in FIG. 9 is started in a state in which the communication apparatus 151 operates in the infrastructure connection mode and is connected to the access point 131.

In S901, the CPU 154 determines whether the infrastructure connection has been disconnected. The disconnection of the infrastructure connection is the disconnection of the connection between the access point 131 and the communication apparatus 151 and is also the disconnection of the connection between the network formed by the access point 131 and the communication apparatus 151. In a case where the result of the determination in S901 is YES, the CPU 154 proceeds to S902. In a case where the result of the determination in S901 is NO, the CPU 154 repeats S901 until the infrastructure connection is disconnected. In a case that a channel used by the access point 131 is switched, the infrastructure connection to the access point 131 is disconnected. Therefore, this processing in S901 corresponds to processing of determining whether the channel used by the access point 131 has been switched. The access point 131 may have a function of notifying the communication apparatus 151 that the channel used by the access point 131 is switched before the infrastructure connection is disconnected due to the switching of the channel used by the access point 131. Therefore, in S901, the CPU 154 may determine whether it has been notified that the channel used by the access point 131 is switched.

In S902, the CPU 154 performs processing of reconnecting to the access point 131 that was previously connected via the infrastructure connection and was disconnected. As the reconnection processing, first, the CPU 154 sequentially uses the channels usable by the communication apparatus 151 to search for the access point 131 that was previously connected via the infrastructure connection and was disconnected. The access point 131 that was previously connected via the infrastructure connection and was disconnected can be specified based on the SSID. In a case that the access point 131 is found, the CPU 154 uses a channel used to find the access point 131 to establish an infrastructure connection to the access point 131. Therefore, the communication apparatus 151 starts to operate in the infrastructure connection mode using the channel used to find the access point 131. A method of searching for the access point 131 that was previously connected via the infrastructure connection and was disconnected is not limited to the above-described method. For example, first, the CPU 154 may search for the access point 131 by using only the channel used for the infrastructure connection via which the access point 131 was previously connected and was disconnected. Thereafter, in a case where the CPU 154 does not find the access point 131 by the search, the CPU 154 may search for the access point 131 by using another channel.

In S903, the CPU 154 stores, to any of the memories included in the communication apparatus 151, information indicating which channel is being used for the infrastructure connection after the channel switching.

In S904, the CPU 154 determines whether the communication apparatus 151 is operating in the direct connection mode. A case where the result of the determination in S904 is YES corresponds to a case where the channel used in the infrastructure connection mode is switched in a state in which the communication apparatus 151 operates the concurrent operation. A case where the result of the determination in S904 is NO corresponds to a case where the channel used in the infrastructure connection mode is switched in a state in which the communication apparatus 151 does not operate the concurrent operation and operates in only the infrastructure connection mode. In a case where the result of the determination in S904 is YES, the CPU 154 proceeds to S905. In a case where the result of the determination in S904 is NO, the CPU 154 ends the process while causing the communication apparatus 151 to operate in only the infrastructure connection mode.

In S905, the CPU 154 determines whether the channel (i.e., the channel after the channel switching) currently used in the infrastructure connection mode matches a channel currently used in the direct connection mode. The channel currently used in the infrastructure connection mode is indicated by the information stored in S903. In a case where the result of the determination in S905 is YES, the CPU 154 proceeds to S906. In a case where the result of the determination in S905 is NO, the CPU 154 proceeds to S908 while causing the communication apparatus 151 to concurrently operate both in the infrastructure connection mode and in the direct connection mode.

In S906, the CPU 154 stops the operation of the communication apparatus 151 in the direct connection mode. Therefore, in a case that the communication apparatus 151 has established the direct connection, the direct connection is disconnected.

In S907, the CPU 154 reactivates the direct connection mode of the communication apparatus 151. That is, the CPU 154 performs the process illustrated in the flowchart of FIG. 7. Therefore, the CPU 154 newly activates the direct connection mode in a state in which the communication apparatus 151 operates in the infrastructure connection mode. In such a case, as described with reference to FIG. 7, the CPU 154 controls the communication apparatus 151 such that a channel different from the channel currently used in the infrastructure connection mode is used in the newly activated direct connection mode.

S908 is the same as or similar to S807 and thus will not be described.

Although the operation of the communication apparatus 151 in the direct connection mode is stopped after the reconnection processing in S902 is performed, the present embodiment is not limited thereto. The CPU 154 may stop the operation of the communication apparatus 151 in the direct connection mode after the infrastructure connection is disconnected in S901 and before the reconnection processing is performed in S902.

Control when Network to which Communication Apparatus is Connected is to be Switched by Wi-Fi Agile Multiband Feature

As described above, a network to which the communication apparatus 151 is connected may be switched by the Wi-Fi Agile Multiband feature in a case that the communication apparatus 151 receives, from an access point, a request to switch the connection destination. Control when a network to which the communication apparatus 151 is connected is to be switched by the Wi-Fi Agile Multiband feature will be described.

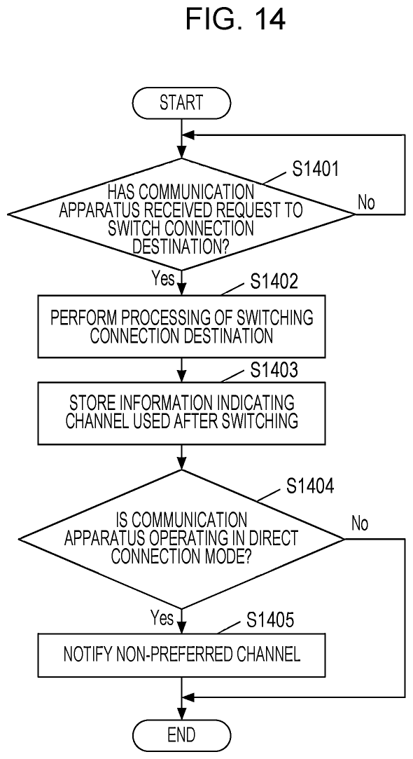

FIG. 14 is a flowchart illustrating a process to be performed by the communication apparatus 151 in the present embodiment. In this flowchart, the process to be performed by the communication apparatus 151 is implemented by the CPU 154 reading various programs stored in a memory such as the ROM 152 into the RAM 153 and executing the programs. It is assumed that the process illustrated in FIG. 14 is started in a state in which the communication apparatus 151 operates in the infrastructure connection mode and is connected to the first network formed by the access point 131.

In S1401, the CPU 154 determines whether the communication apparatus 151 has received, from the access point 131, a request to switch the connection destination by the Wi-Fi Agile Multiband feature. In a case where the result of the determination in S1401 is YES, the CPU 154 proceeds to S1402. In a case where the result of the determination in S1401 is NO, the CPU 154 repeats S1401 until the communication apparatus 151 receives the request to switch the connection destination from the access point 131.

In S1402, the CPU 154 disconnects the connection between the first network and the communication apparatus 151 and performs processing of establishing a connection between the communication apparatus 151 and a network corresponding to information included in the request to switch the connection destination. The processing in S1402 corresponds to S507 to S509.

In S1403, the CPU 154 stores, to any of the memories included in the communication apparatus 151, information indicating which channel is being used for the infrastructure connection after the switching of the connection destination.

In S1404, the CPU 154 determines whether the communication apparatus 151 is operating in the direct connection mode. A case where the result of the determination in S1404 is YES corresponds to a case where the network that is the connection destination is switched by the Wi-Fi Agile Multiband feature in a state in which the communication apparatus 151 performs the concurrent operation. A case where the result of the determination in S1404 is NO corresponds to a case where the network that is the connection destination is switched by the Wi-Fi Agile Multiband feature in a state in which the communication apparatus 151 does not perform the concurrent operation and operates in only the infrastructure connection mode. In a case where the result of the determination in S1404 is YES, the CPU 154 proceeds to S1405. In a case where the result of the determination in S1404 is NO, the CPU 154 ends the process.

S1405 is the same as or similar to S807 and thus will not be described.

In this flowchart, processing that is the same as or similar to S804 to S806 and S905 to S907 is not performed. This is due to the fact that processing of notifying a non-preferred channel is performed and thus the communication apparatus 151 is controlled such that the channel used for the infrastructure connection does not match the channel used for the direct connection, depending on the Wi-Fi Agile Multiband feature.

In the embodiment described above, the communication apparatus 151 is controlled such that the channel used for the infrastructure connection does not match the channel used for the direct connection, depending on the Wi-Fi Agile Multiband feature.

It is assumed that the direct connection mode of the communication apparatus 151 is stopped by a user operation performed on the communication apparatus 151 in a state in which the communication apparatus 151 performs the concurrent operation and a non-preferred channel is notified to an access point to which the communication apparatus 151 is connected. In this case, the control to prevent the network to which the communication apparatus 151 is connected in the infrastructure connection mode from being switched by Wi-Fi Agile Multiband to a network in which a channel currently used by the communication apparatus 151 in the direct connection mode is used is released. Specifically, the communication apparatus 151 notifies the access point to which the communication apparatus 151 is connected that the communication apparatus 151 does not designate any channel as a non-preferred channel. More specifically, the communication apparatus 151 transmits information indicating no channel to the access point forming the network to which the communication apparatus 151 is connected. The information is, for example, a BSS Transition Management (BTM) request frame defined in the IEEE802.11v standard and has no information in a non-preferred channel designation field. The access point to which the communication apparatus 151 is connected can use the Wi-Fi Agile Multiband feature to specify a new destination to which the communication apparatus 151 will be connected without being restricted by a channel.

### Second Embodiment

In the above description, in a case that the infrastructure connection mode is newly activated in a state in which the communication apparatus 151 operates in the direct connection mode, a channel used in the direct connection mode is switched regardless of whether the communication apparatus 151 has established the direct connection.

It the present embodiment, a mode will be described in which in a case that the infrastructure connection mode is newly activated in a state in which the communication apparatus 151 operates in the direct connection mode but does not establish the direct connection, a channel used in the direct connection mode is not switched.

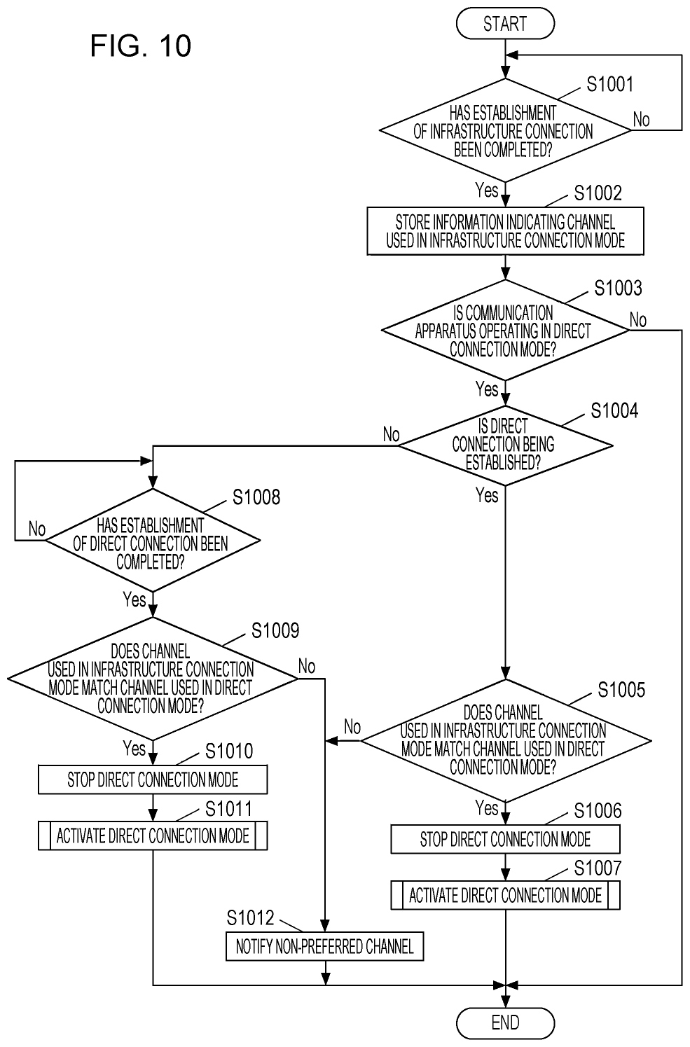

A configuration of a communication system according to the present embodiment is the same as or similar to that described in the first embodiment, unless otherwise specified. Specifically, in the present embodiment, a process illustrated in a flowchart of FIG. 10 is performed instead of the process illustrated in the flowchart of FIG. 9 in the first embodiment, but other processes are performed with the same contents as those illustrated in the flowcharts described above.

### Control When Infrastructure Connection Mode is to be Newly Activated

FIG. 10 is a flowchart illustrating a process to be performed by the communication apparatus 151 in the present embodiment. In this flowchart, the process to be performed by the communication apparatus 151 is implemented by the CPU 154 reading various programs stored in a memory such as the ROM 152 into the RAM 153 and executing the programs. It is assumed that the process illustrated in FIG. 10 is started in a case that the communication apparatus 151 receives, from the user, the operation for activating the infrastructure connection mode described above, and tries to establish a connection to the access point 131 as described with reference to FIG. 4.

S1001 to S1003 are the same as or similar to S801 to S803, respectively, and thus will not be described.

In S1004, the CPU 154 determines whether the direct connection is being established by the communication apparatus 151. A case where the result of the determination in S1004 is YES corresponds to a case where the communication apparatus 151 operates in the direct connection mode and the direct connection is established by the communication apparatus 151. On the other hand, a case where the result of the determination in S1004 is NO corresponds to a case where the communication apparatus 151 operates in the direct connection mode but the direct connection is not established by the communication apparatus 151. In a case where the result of the determination is YES, the CPU 154 proceeds to S1005. In a case where the result of the determination is NO, the CPU 154 proceeds to S1008.

S1005 to S1007 are the same as or similar to S804 to S806, respectively, and thus will not be described. In a case where the result of the determination in S1005 is NO, the CPU 154 proceeds to S1012.

It S1008, the CPU 154 determines whether the communication apparatus 151 has completed the establishment of the direct connection. In a case where the result of the determination in S1008 is YES, the CPU 154 proceeds to S1009. In a case where the result of the determination in S1008 is NO, the CPU 154 repeats S1008 until the establishment of the direct connection is completed. In a case that the infrastructure connection is disconnected before the completion of the establishment of the direct connection, the CPU 154 ends the process.

S1009 to S1011 are the same as or similar to S804 to S806, respectively, and thus will not be described. In a case where the result of the determination in S1009 is NO, the CPU 154 proceeds to S1012.

S1012 is the same as or similar to S807 and thus will not be described.

Even the control described in the present embodiment can make a channel used in the infrastructure connection mode different from a channel used in the direct connection mode. In addition, since the above-described process is performed, it is possible to continue the communication while the channel used in the infrastructure connection mode is different from the channel used in the direct connection mode. Therefore, it is possible to suppress the occurrence of interference in the communication in the infrastructure connection mode and the communication in the direct connection mode.

### Third Embodiment

In the above-described embodiments, as the processing of establishing the infrastructure connection, the communication apparatus 151 sequentially uses the channels usable by the communication apparatus 151 to search for access points present around the communication apparatus 151 and displays a list of one or more access points found by the search. The communication apparatus 151 establishes an infrastructure connection to an access point selected from the list.

In the present embodiment, a mode will be described in which the communication apparatus 151 searches for an access point present around the communication apparatus 151 by using a method different from the methods described in the above-described embodiments and makes a channel used in the infrastructure connection mode different from a channel used in the direct connection mode.

A configuration of a communication system according to the present embodiment is the same as or similar to that described in each of the first and second embodiments, unless otherwise specified.

### Control to Search for Access Point Around Communication Apparatus 151

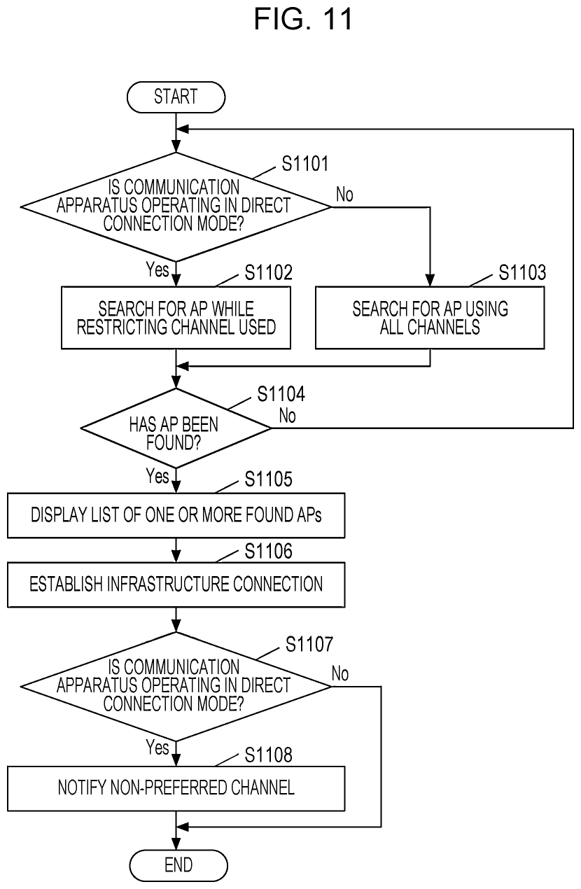

FIG. 11 is a flowchart illustrating a process to be performed by the communication apparatus 151 in the present embodiment. In this flowchart, the process to be performed by the communication apparatus 151 is implemented by the CPU 154 reading various programs stored in a memory such as the ROM 152 into the RAM 153 and executing the programs. It is assumed that the process illustrated in FIG. 11 is started in a case that the communication apparatus 151 receives, from the user, the operation for activating the infrastructure connection mode described above.

In S1101, the CPU 154 determines whether the communication apparatus 151 is operating in the direct connection mode. In a case where the result of the determination in S1101 is YES, the CPU 154 proceeds to S1102. In a case where the result of the determination in S1101 is NO, the CPU 154 proceeds to S1103.

In S1102, the CPU 154 specifies a channel used by the communication apparatus 151 in the direct connection mode. The communication apparatus 151 searches for an access point present around the communication apparatus 151 by sequentially using channels that are among all the channels usable by the communication apparatus 151 and exclude the channel used by the communication apparatus 151 in the direct connection mode. All the channels usable by the communication apparatus 151 are the channels for the 2.4 GHz frequency band and the channels for the 5 GHz frequency band including the DFS band. A search for an access point present around the communication apparatus 151 is referred to as an AP search. After S1102, the CPU 154 proceeds to S1103.

In S1103, the CPU 154 searches for an access point present around the communication apparatus 151 by sequentially using all the channels usable by the communication apparatus 151.

In S1104, the CPU 154 determines whether one or more access points have been found by the AP search. In a case where the result of the determination in S1104 is YES, the CPU 154 proceeds to S1105. In a case where the result of the determination in S1104 is NO, the CPU 154 returns to S1101. In a case that any access point is not found by the AP search regardless of repetition of the processing in S1104 and a time-out time elapses, the CPU 154 may end the AP search, end the process, and display a screen indicating that any access point has not been found.

In S1105, the CPU 154 displays a list of the one or more access points found by the AP search. Then, the communication apparatus 151 receives selection by the user from the list. In the present embodiment, as described above, the communication apparatus 151 is controlled to prevent the channel used by the communication apparatus 151 in the direct connection mode from being used for the AP search. Therefore, as a result, the list does not include an access point that uses the channel used by the communication apparatus 151 in the direct connection mode.

In S1106, the CPU 154 transmits a connection request to the selected access point and establishes an infrastructure connection to the selected access point. For the transmission of the connection request and communication via the established infrastructure connection, the channel used to search for and find the selected access point is used. After S1106, the CPU 154 proceeds to S1107.

In S1107, the CPU 154 determines whether the communication apparatus 151 is operating in the direct connection mode. In a case where the result of the determination in S1107 is YES, the CPU 154 proceeds to S1108. In a case where the result of the determination in S1107 is NO, the CPU 154 ends the process.

S1108 is the same as or similar to S807 and thus will not be described.

In a mode in which the infrastructure connection is established by the first method, due to the control described in the present embodiment, the channel used in the direct connection mode is not identical to the channel used in the infrastructure connection mode. Therefore, the channel used in the direct connection mode can be different from the channel used in the infrastructure connection mode. In addition, since the above-described process is performed, the communication can be continued while the channel used in the infrastructure connection mode is different from the channel used in the direct connection mode. Therefore, it is possible to suppress the occurrence of interference in the communication in the infrastructure connection mode and the communication in the direct connection mode.

In a case that the present embodiment is applied, S803 to S806 may not be performed in the process illustrated in the flowchart of FIG. 8. However, in a case where the infrastructure connection is established by the second method or the third method, S803 to S806 may be performed in the process illustrated in the flowchart of FIG. 8. That is, based on a method for establishing the infrastructure connection, whether S803 to S806 are performed may be controlled in the process illustrated in the flowchart of FIG. 8.

The control according to the present embodiment may be applied to an AP search other than an AP search that is started in a case that the communication apparatus 151 receives, from the user, an operation for activating the infrastructure connection mode. Specifically, for example, the control according to the present embodiment may be applied to the reconnection processing in S902 in the flowchart of FIG. 9. More specifically, in a state in which the communication apparatus 151 operates in the direct connection mode, the communication apparatus 151 may search for the access point 131 by sequentially using channels that are among all the channels usable by communication apparatus 151 and exclude the channel used by the communication apparatus 151 in the direct connection mode.

### Fourth Embodiment

In a fourth embodiment, a mode will be described in which a search for an access point present around the communication apparatus 151 is performed by a different method from the searches described above in the embodiments and a channel used in the infrastructure connection mode is different from a channel used in the direct connection mode.

### Control to Search for Access Point Around Communication Apparatus 151

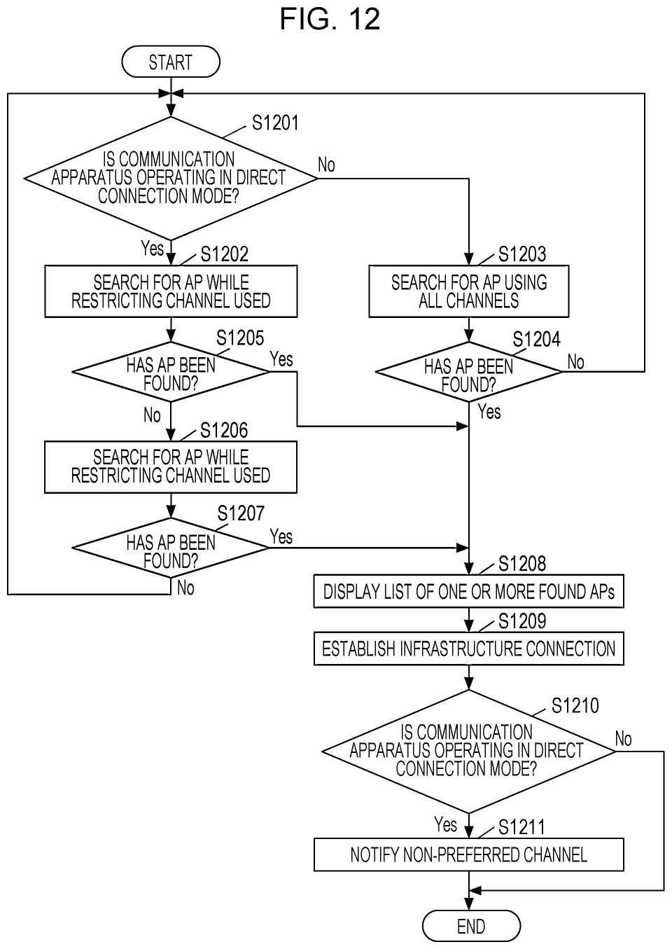

FIG. 12 is a flowchart illustrating a process to be performed by the communication apparatus 151 in the present embodiment. In this flowchart, the process to be performed by the communication apparatus 151 is implemented by the CPU 154 reading various programs stored in a memory such as the ROM 152 into the RAM 153 and executing the programs. It is assumed that the process illustrated in FIG. 12 is started in a case that the communication apparatus 151 receives, from the user, the operation for activating the infrastructure connection mode described above.

A configuration of a communication system according to the present embodiment is the same as or similar to that in each of the above-described embodiments, unless otherwise specified. Specifically, in the present embodiment, the process illustrated in the flowchart of FIG. 12 is performed instead of the process illustrated in the flowchart of FIG. 11 in the third embodiment, but other processes are performed with the same contents as those illustrated in the flowcharts described above.

S1201 to S1204 are the same as or similar to S1101 to S1104, respectively, and thus will not be described.

In S1205, the CPU 154 determines whether one or more access points have been found by an AP search in S1202. In a case where the result of the determination in S1205 is YES, the CPU 154 proceeds to S1208. In a case where the result of the determination in S1205 is NO, the CPU 154 proceeds to S1206.

In S1206, the CPU 154 searches for an access point present around the communication apparatus 151 by using a channel used by the communication apparatus 151 in the direct connection mode. In this processing, at least the channel used by the communication apparatus 151 in the direct connection mode may be used. Therefore, for example, in this processing, the CPU 154 may search for an access point present around the communication apparatus 151 by sequentially using all the channels usable by the communication apparatus 151.

In S1207, the CPU 154 determines whether one or more access points have been found by the AP search in S1206. In a case where the result of the determination in S1207 is YES, the CPU 154 proceeds to S1208. In a case where the result of the determination in S1207 is NO, the CPU 154 returns to S1201. In a case that any access point is not found by the AP search regardless of repetition of the processing in S1207 and a time-out time elapses, the CPU 154 may end the AP search, end the process, and display a screen indicating that any access point has not been found.

S1208 to S1211 are the same as or similar to S1105 to S1108, respectively, and thus will not be described.

The control according to the present embodiment can be performed to prevent an infrastructure connection for which a channel used in the direct connection mode is used from being established as much as possible. Therefore, it is possible to suppress the occurrence of interference in communication in the infrastructure connection mode and communication in the direct connection mode. In addition, in a case where an access point is not found by the AP search using a channel used in the direct connection mode, the probability that an access point is found can be increased by performing an AP search using the channel used in the direct connection mode.

The control according to the present embodiment may be applied to an AP search other than an AP search that is started in a case that the communication apparatus 151 receives, from the user, an operation for activating the infrastructure connection mode. Specifically, for example, the control according to the present embodiment may be applied to the reconnection processing in S902 in the flowchart of FIG. 9. More specifically, in a state in which the communication apparatus 151 operates in the direct connection mode, the communication apparatus 151 may search for the access point 131 by sequentially using channels that are among all the channels usable by the communication apparatus 151 and exclude the channel used by the communication apparatus 151 in the direct connection mode. In a case where the access point 131 is not found by the AP search, the communication apparatus 151 may search for the access point 131 by using the channel used by the communication apparatus 151 in the direct connection mode.

### Fifth Embodiment

In the above-described embodiments, the mode is described above in which a channel used in the infrastructure connection mode does not match a channel used in the direct connection mode, but a frequency band used in the infrastructure connection mode may match a frequency band used in the direct connection mode.

In the present embodiment, a mode will be described in which control is performed such that a channel used in the infrastructure connection mode does not match a channel used in the direct connection mode and that a frequency band used in the infrastructure connection mode does not match a frequency band used in the direct connection mode.

### Control When Direct Connection Mode is to be Newly Activated

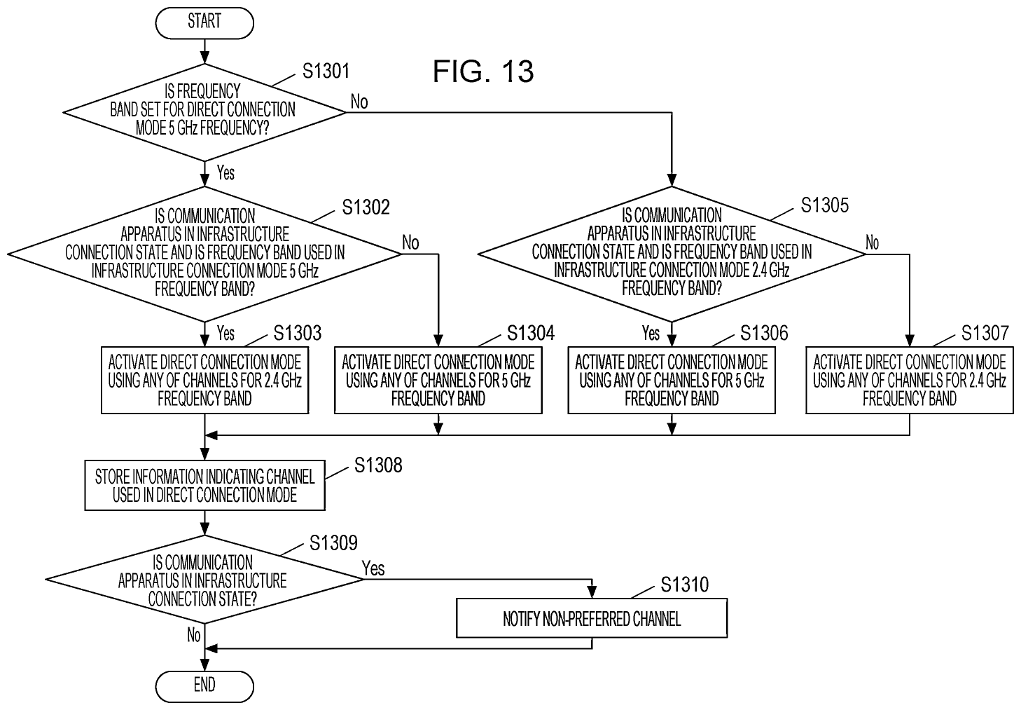

FIG. 13 is a flowchart illustrating a process to be performed by the communication apparatus 151 in the present embodiment. In the flowchart of FIG. 13, the process to be performed by the communication apparatus 151 is implemented by the CPU 154 reading various programs stored in a memory such as the ROM 152 into the RAM 153 and executing the programs. It is assumed that the process illustrated in FIG. 13 is started in a case that processing as a trigger for activating the direct connection mode is performed, for example, in a case that the communication apparatus 151 receives, from the user, the operation for activating the direct connection mode described above.

S1301 is the same as or similar to S701 and thus will not be described.

In S1302, the CPU 154 determines whether the communication apparatus 151 is in the infrastructure connection state. In a case that the communication apparatus 151 is in the infrastructure connection state, the CPU 154 specifies a frequency band used in the infrastructure connection mode and determines whether the frequency band used in the infrastructure connection mode is the 5 GHz frequency band. That is, in the processing in S1302, the CPU 154 determines whether the communication apparatus 151 is in the infrastructure connection state, and determines whether the frequency band used in the infrastructure connection mode is the 5 GHz frequency band. For example, the frequency band used in the infrastructure connection mode is specified based on the specifying of the channel used in the infrastructure connection mode. The specified frequency band corresponds to the frequency band used in the infrastructure connection mode when the processing as the trigger for activating the direct connection mode is performed. A case where the frequency band used in the infrastructure connection mode is the 5 GHz frequency band is a case where the channel used in the infrastructure connection mode is a channel for the 5 GHz frequency band. In a case where the result of the determination in S1302 is YES, the CPU 154 proceeds to S1303. In a case where the result of the determination in S1302 is NO, the CPU 154 proceeds to S1304.

In S1303, the CPU 154 sets, as a channel to be used in the direct connection mode, any one of the channels for the 2.4 GH frequency band that are usable by the communication apparatus 151, and activates the direct connection mode. After S1303, the CPU 154 proceeds to S1304. In this case, a channel to be preferentially used among the channels for the 2.4 GHz frequency band that are usable by the communication apparatus 151 may be set in advance. Specifically, for example, as the channel to be used in the direct connection mode, the channel 11 may be preferentially set. In this case, the CPU 154 may automatically set a frequency band set on the screen illustrated in FIG. 2E to the 2.4 GHz frequency band. In addition, in this case, the CPU 154 may display a screen for notifying the user that the 2.4 GHz frequency band is to be used in the direct connection mode.

In S1304, the CPU 154 sets, as a channel to be used in the direct connection mode, any one of the channels for the 5 GHz frequency band that are usable by the communication apparatus 151, and activates the direct connection mode. After S1304, the CPU 154 proceeds to S1308. In this case, a channel to be preferentially used among the channels for the 5 GHz frequency band that are usable by the communication apparatus 151 may be set in advance. Specifically, for example, as the channel to be used in the direct connection mode, the channel 36 may be preferentially set.

In S1305, the CPU 154 determines whether the communication apparatus 151 is in the infrastructure connection state. In a case that the communication apparatus 151 is in the infrastructure connection state, the CPU 154 specifies a frequency band used in the infrastructure connection mode and determines whether the frequency band used in the infrastructure connection mode is the 2.4 GHz frequency band. That is, in the processing in S1305, the CPU 154 determines whether the communication apparatus 151 is in the infrastructure connection state, and determines whether the frequency band used in the infrastructure connection mode is the 2.4 GHz frequency band. The specified frequency band corresponds to the frequency band used in the infrastructure connection mode in a case that the processing as the trigger for activating the direct connection mode is performed. The frequency band used in the infrastructure connection mode is specified based on the specifying of the channel used in the infrastructure connection mode. A case where the frequency band used in the infrastructure connection mode is the 2.4 GHz frequency band is a case where the channel used in the infrastructure connection mode is a channel for the 2.4 GHz frequency band. In a case where the result of the determination in S1305 is YES, the CPU 154 proceeds to S1306. In a case where the result of the determination in S1305 is NO, the CPU 154 proceeds to S1307.

In S1306, the CPU 154 sets, as a channel to be used in the direct connection mode, any one of the channels for the 5 GHz frequency band that are usable by the communication apparatus 151, and activates the direct connection mode. After S1306, the CPU 154 proceeds to S1308. In this case, the CPU 154 may control to set any one of channels that are among the channels for the 5 GHz frequency band that are usable by the communication apparatus 151 and exclude the channels for the DFS band. In this case, a channel to be preferentially used among the channels for the 5 GHz frequency band that are usable by the communication apparatus 151 may be determined. Specifically, for example, as the channel to be used in the direct connection mode, the channel 36 may be preferentially set. In addition, in this case, the CPU 154 may automatically set the frequency band set on the screen illustrated in FIG. 2E to the 5 GHz frequency band. In this case, the CPU 154 may display a screen for notifying the user that the 5 GHZ frequency band is to be used in the direct connection mode.

In S1307, the CPU 154 sets, as a channel to be used in the direct connection mode, any one of the channels for the 2.4 GHz frequency band that are usable by the communication apparatus 151, and activates the direct connection mode. In this case, a channel to be preferentially used among the channels for the 2.4 GHz frequency band that are usable by the communication apparatus 151 may be determined. Specifically, for example, as the channel to be used in the direct connection mode, the channel 11 may be preferentially set. After S1307, the CPU 154 proceeds to S1308.

Processing in S1308 to S1310 is the same as or similar to the processing in S708 to S710 and thus will not be described.

Since the above-described process is performed, in a case that an operation for activating the direct connection mode is performed on the communication apparatus 151 in a state in which the communication apparatus 151 operates in the infrastructure connection mode, the channel used in the infrastructure connection mode can be different from the channel used in the direct connection mode. Therefore, it is possible to suppress the occurrence of interference in the communication in the infrastructure connection mode and the communication in the direct connection mode. In the present embodiment, the 2.4 GHz frequency band or the 5 GHz frequency band is used as an example, but the 6 GHz frequency band may be used.

In the above-described embodiment, the control can be performed to prevent the frequency band used in the infrastructure connection mode from matching the frequency band used in the direct connection mode. Therefore, it is possible to suppress the occurrence of interference in the communication in the infrastructure connection mode and the communication in the direct connection mode.

### OTHER EMBODIMENTS

In the above description, as the predetermined control to prevent the channel used in the infrastructure connection mode from matching the channel used in the direct connection mode by the Wi-Fi Agile Multiband feature, the control is performed such that the channel used in the direct connection mode is notified to the access point and a network in which the channel used in the direct connection mode is used is not specified as a switching target network. However, the embodiments are not limited thereto. For example, the predetermined control may be performed such that the channel used in the direct connection mode is not notified to the access point. In a case where the network in which the channel used in the direct connection mode is used is specified as a switching target network, and a request that has been received by the communication apparatus 151 and is to switch the connection destination includes the SSID of the network in which the channel used in the direct connection mode is used, the predetermined control may be performed such that the destination to which the communication apparatus 151 is connected is not switched and the connection to the network to which the communication apparatus 151 is originally connected is maintained. Even in this embodiment, in a case where a network in which a channel different from the channel used in the direct connection mode is used is specified as a switching target network, and a request that has been received by the communication apparatus 151 and is to switch the connection destination includes the SSID of the network in which the channel different from the channel used in the direct connection mode is used, the destination to which the communication apparatus 151 is connected is switched based on the request to switch the connection destination.

The object of various embodiments of the present disclosure can be achieved by supplying a recording medium (storing a program code of software) for implementing the example functions described above to a system or an apparatus and a computer (or CPU or MPU, for example) of the system or the apparatus reading and executing the program code stored in the recording medium. In such cases, the program code read from the recording medium, when executed, implements the functions described above, and the recording medium storing the program code is included within the scope of the present disclosure.

As the recording medium for storing the program code, a flexible disk, a hard disk, an optical disc, a magneto-optical disc, a CD-ROM, a CD-R, a magnetic tape, a nonvolatile memory card, a ROM, a DVD, and the like can be used.

The computer reads and executes the program code to not only implement the functions described in the above description of embodiments but also performs some or all of the processes executed by the operating system (OS) or the like on the computer so as to implement the functions described above by the processes.

According to various embodiments of the present disclosure, it is possible to improve the convenience of the apparatus that can operate in a mode as a slave station and operate in a mode as a master station.

Various embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While exemplary embodiments have been described, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2023-107819, filed Jun. 30, 2023, which is hereby incorporated by reference herein in its entirety.

What is claimed is:

1. A communication apparatus that can operate in a first mode as a slave station compliant with a predetermined wireless communication standard and operate in a second mode as a master station compliant with the predetermined wireless communication standard, the communication apparatus comprising:
a specifying unit that specifies, in a case that specific processing for causing the communication apparatus to operate in the first mode is performed in a state in which the communication apparatus operates in the second mode, a channel (i) that is different from a channel used by the communication apparatus in the second mode when the specific processing is performed and (ii) that is to be used by the communication apparatus in the second mode after the specific processing is performed, based on a match between the channel used by the communication apparatus in the second mode when the specific processing is performed and a channel used by the communication apparatus in the first mode started by the specific processing;
a first control unit that controls the communication apparatus such that the communication apparatus concurrently operates in the first mode and the second mode, and operates in the second mode using the specified channel in a case that the specific processing is performed in a state in which the communication apparatus operates in the second mode;
a switching unit that switches a destination to which the communication apparatus is connected in the first mode from a first network to a second network based on reception of predetermined information by the communication apparatus via the first network to which the communication apparatus is connected in the first mode in a state in which the communication apparatus operates in the first mode, the predetermined information being provided for switching the destination to which the communication apparatus is connected in the first mode from the first network to the second network; and
a second control unit that performs, in a state in which the communication apparatus concurrently operates in the first mode and in the second mode, predetermined control to prevent the destination to which the communication apparatus is connected in the first mode from being switched based on the predetermined information, from the first network to a network in which the channel used by the communication apparatus in the second mode is used.

2. The communication apparatus according to claim 1, wherein
the predetermined information includes identification information of the second network,
the destination to which the communication apparatus is connected in the first mode is switched from the first network to the second network based on the identification information of the second network, and
the predetermined control is performed to prevent identification information of the network in which the channel used by the communication apparatus in the second mode is used from being included in the predetermined information received by the communication apparatus as the identification information of the second network.

3. The communication apparatus according to claim 2, wherein
the predetermined control is performed to notify an access point forming the first network of the channel used by the communication apparatus in the second mode.

4. The communication apparatus according to claim 3, wherein
the channel used by the communication apparatus in the second mode is notified to the access point forming the first network based on the communication apparatus starting to concurrently operate in the first mode and in the second mode.

5. The communication apparatus according to claim 1, wherein
the predetermined information includes identification information of the second network,
the destination to which the communication apparatus is connected in the first mode is switched from the first network to the second network based on the identification information of the second network, and
the predetermined control is performed to prevent the destination to which the communication apparatus is connected in the first mode from being switched from the first network to the second network even in a case where identification information of the network in which the channel used by the communication apparatus in the second mode is used is included in the predetermined information received by the communication apparatus as the identification information of the second network.

6. The communication apparatus according to claim 1, wherein
the destination to which the communication apparatus is connected in the first mode is switched from the first network to the second network by using a password for the connection to the first network based on the reception of the predetermined information.

7. The communication apparatus according to claim 1, wherein
an SSID of the first network is identical to an SSID of the second network.

8. The communication apparatus according to claim 1, further comprising
a transmission unit that transmits network information indicating one or more networks present around the communication apparatus to an access point forming the first network, wherein
the second network corresponding to the predetermined information is any one of the one or more networks indicated by the network information.

9. The communication apparatus according to claim 8, wherein
the network information indicating the one or more networks present around the communication apparatus indicates one or more networks having an SSID identical to an SSID of the first network among the one or more networks present around the communication apparatus.

10. The communication apparatus according to claim 1, wherein
the switching of the destination to which the communication apparatus is connected in the first mode based on the reception of the predetermined information is performed by Wi-Fi Agile Multiband.

11. The communication apparatus according to claim 1, further comprising:
a stop unit that stops the operation of the communication apparatus in the second mode in a case that the specific processing is performed in a state in which the communication apparatus operates in the second mode; and
a restarting unit that restarts the operation of the communication apparatus in the second mode after the operation of the communication apparatus in the second mode is stopped, wherein
the channel different from the channel used by the communication apparatus in the second mode when the specific processing is performed is specified as a channel to be used by the communication apparatus in the second mode in which the operation has been restarted.

12. The communication apparatus according to claim 1, wherein
the specific processing is at least one of (i) processing of receiving, from a user, selection of an access point from a list of one or more access points found in a search by the communication apparatus, (ii) processing of receiving, from the user, an operation for executing Wi-Fi Protected Setup or AirStation One-Touch Secure System, and (iii) processing of re-establishing a connection between the communication apparatus in the first mode and an access point due to disconnection of a connection between the communication apparatus in the first mode and the access point.

13. The communication apparatus according to claim 1, wherein
in a case that predetermined processing for causing the communication apparatus to operate in the second mode is performed in a state in which the communication apparatus operates in the first mode, a channel different from the channel used by the communication apparatus in the first mode when the predetermined processing is performed is specified as the channel to be used by the communication apparatus in the second mode after the predetermined processing is performed.

14. The communication apparatus according to claim 13, wherein
in a case that the predetermined processing is performed in a state in which the communication apparatus operates in the first mode, a channel different from a predetermined channel set as a channel to be preferentially used by the communication apparatus in the second mode is specified as the channel to be used by the communication apparatus in the second mode after the predetermined processing is performed, based on a match between the predetermined channel and the channel used by the communication apparatus in the first mode when the predetermined processing is performed.

15. The communication apparatus according to claim 1, wherein
the second mode is at least one of a mode in which the communication apparatus operates as a software access point and a mode in which the communication apparatus operates as a group owner for Wi-Fi Direct.

16. The communication apparatus according to claim 1, wherein
the predetermined wireless communication standard is included in IEEE802.11 series of standards.

17. The communication apparatus according to claim 1, further comprising
at least one of a printing unit that performs printing and a scanning unit that performs scanning.

18. The communication apparatus according to claim 1, wherein
a 2.4 GHz frequency band and a 5 GH frequency band are available for use in communication in the first mode, and
the 2.4 GHz frequency band and a frequency band that is included in the 5 GHz frequency band and for which a channel is not switched by Dynamic Frequency Selection are available for use in communication in the second mode, or the 2.4 GHz frequency band is available for use in communication in the second mode and the 5 GH frequency band is not available for use in communication in the second mode.

19. The communication apparatus according to claim 1, wherein
at least a 6 GHz frequency band is available for use in communication in the first mode.

20. A method of controlling a communication apparatus that can operate in a first mode as a slave station compliant with a predetermined wireless communication standard and operate in a second mode as a master station compliant with the predetermined wireless communication standard, the method comprising:
specifying, in a case that specific processing for causing the communication apparatus to operate in the first mode is performed in a state in which the communication apparatus operates in the second mode, a channel (i) that is different from a channel used by the communication apparatus in the second mode when the specific processing is performed and (ii) that is to be used by the communication apparatus in the second mode after the specific processing is performed, based on a match between the channel used by the communication apparatus in the second mode when the specific processing is performed and a channel used by the communication apparatus in the first mode started by the specific processing;
controlling the communication apparatus such that the communication apparatus concurrently operates in the first mode and the second mode, and operates in the second mode using the specified channel in a case that the specific processing is performed in a state in which the communication apparatus operates in the second mode;
switching a destination to which the communication apparatus is connected in the first mode from a first network to a second network based on reception of predetermined information by the communication apparatus via the first network to which the communication apparatus is connected in the first mode in a state in which the communication apparatus operates in the first mode, the predetermined information being provided for switching the destination to which the communication apparatus is connected in the first mode from the first network to the second network; and
performing, in a state in which the communication apparatus concurrently operates in the first mode and in the second mode, predetermined control to prevent the destination to which the communication apparatus is connected in the first mode from being switched based on the predetermined information, from the first network to a network in which the channel used by the communication apparatus in the second mode is used.
